(19) United States
(12) Patent Application Publication
(10) Pub. No.: US 2007/0272770 A1
(43) Pub. Date: Nov. 29, 2007

(54) APPARATUS AND METHODS FOR A SHOWERHEAD BRACKET WITH INTEGRAL SHOWERHEAD

(75) Inventors: Leland C. Leber, Fort Collins, CO (US); Harold A. Luettgen, Windsor, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: Water Pik, Inc., Fort Collins, CO (US)

(21) Appl. No.: 11/754,980

(22) Filed: May 29, 2007

Related U.S. Application Data
(60) Provisional application No. 60/803,350, filed on May 26, 2006.
(60) Provisional application No. 60/916,219, filed on May 4, 2007.

(51) Int. Cl. B05B 1/32; B05B 9/01; B05B 1/30

(52) U.S. Cl. 239/451; 239/569; 239/525

(57) ABSTRACT

A showerhead assembly may include a showerhead bracket for attaching a conventional handheld showerhead to the showerhead assembly. A coupling member may join the showerhead assembly to a shower pipe, and a showerhead may be joined to the showerhead bracket to deliver water or other fluid from the showerhead assembly. The showerhead bracket may be selectively rotatable and/or pivotable relative to the coupling member, the showerhead, or both to change the direction water exits the showerhead assembly relative the showerhead pipe. The showerhead assembly may operate in one or more modes, which may include at least one off mode. The showerhead assembly operation mode may be selected by rotating at least some components of the showerhead relative to the showerhead bracket. Some showerhead assemblies may include a diverter valve to selectively control the flow of fluid from the showerhead pipe to the showerhead and the handheld showerhead.

### CROSS-REFERENCE TO RELATED APPLICATIONS

This application claims under 35 U.S.C. §119(e) the benefit of U.S. Provisional Application No. 60/803,350, entitled “Shower Bracket with Integral Showerhead” and filed on May 26, 2006, and U.S. Provisional Application No. 60/916,219, entitled “Hidden Pivot Attachment For Showers and Method of Making Same” and filed on May 4, 2007, the disclosures of which are hereby incorporated by reference herein in their entireties.

### INCORPORATION BY REFERENCE

The following U.S. Patents and Patent Publications are hereby incorporated by reference herein in their entireties:

U.S. Pat. No. 6,230,989, entitled “Multi Functional Shower Head” and issued on May 15, 2001;

U.S. Pat. No. 6,454,186, entitled “Multi Functional Shower Head” and issued on Sep. 24, 2002;

U.S. Pat. No. 6,739,523, entitled “Multi Functional Shower Head” and issued on May 25, 2004; and

U.S. Pat. Publication No. 2005/0098485, entitled “End-of-Faucet Filter” and published on May 12, 2005.

### BACKGROUND OF THE INVENTION

a. Field of the Invention

The present invention relates generally to shower hardware, and more particularly to a showerhead bracket.

b. Background

Combination showerhead brackets may supply water from a shower pipe to conventional and handheld showerheads. Typically, these brackets are attached to a shower pipe using a pivot ball and may have an integral diverter valve. Generally, the diverter valve may be selectively positioned to cause water flow from the shower pipe to flow generally downward to a connection point for a hose connected to a handheld showerhead, to flow forward to a connection point for a conventional wall mounted showerhead, to flow to neither connection point, or to flow to both connection points. A clamp may be joined with the bracket, typically to the bracket's side, to hold to handheld showerhead.

Although the above-described combination showerhead brackets are functional, they often occupy a relatively large amount of space and may not provide a wide-range of directional control for water exiting the conventional showerhead. Further, they often are not visually pleasing and may require more than an optimum amount of material to build.

### BRIEF SUMMARY

An example of the present invention may take the form of a showerhead assembly including a showerhead bracket and a showerhead. The showerhead bracket may include a fluid chamber and a slot. The slot may be configured to securely and releasably receive a handheld showerhead. The showerhead may be operatively associated with the showerhead bracket and in fluid communication with the fluid chamber. At least a portion of the showerhead may be received within the fluid chamber, and the showerhead may be selectively movable relative to the showerhead bracket.

Another example of the present invention may take the form of a showerhead assembly again including a showerhead bracket and a showerhead. Like the first example, the showerhead bracket may include fluid chamber. The second example differs from the first example in that the showerhead bracket may include a slot aligned along a longitudinal axis of the showerhead bracket and configured to securely and releasably receive a handheld showerhead. The second example also differs from the first example in that the showerhead bracket may include a fluid inlet in fluid communication with the fluid chamber and a fluid outlet in fluid communication with the fluid inlet. The second further differs from the first example in that the showerhead may or may not be movable selectively movable relative to the showerhead bracket. Like the first example, the showerhead may be operatively associated with the showerhead bracket and in fluid communication with the fluid chamber, and at least a portion of the showerhead may be received within the fluid chamber.

A method for providing a fluid spray from a shower pipe may include obtaining a showerhead assembly and fluidly connecting the showerhead assembly to a showerhead pipe. The showerhead assembly may include a showerhead bracket and a showerhead. The showerhead bracket may include a slot configured to securely and releasably receive a handheld showerhead, a fluid chamber, a fluid inlet in fluid communication with the fluid chamber, and a fluid outlet in fluid communication with the fluid inlet. The showerhead may be in fluid communication with the fluid chamber, may be operatively associated with the showerhead bracket, and may be selectively movable relative to the showerhead bracket. At least a portion of the showerhead may be received within the fluid chamber. A fluid inlet of the showerhead bracket may be fluidly connected to a fluid outlet of the showerhead pipe.

### BRIEF DESCRIPTION OF THE DRAWINGS

FIG. 1 depicts a perspective view of a first example of a showerhead assembly.

FIG. 2A depicts a cross-sectional view of the showerhead assembly depicted in FIG. 1, viewed along line 2A-2A.

FIG. 2B depicts another cross-sectional view of the showerhead assembly depicted in FIG. 1, viewed along line 2B-2B.

FIG. 3A depicts a perspective view of a showerhead bracket for the showerhead assembly depicted in FIG. 1.

FIG. 3B depicts another perspective view of the showerhead bracket depicted in FIG. 3A.

FIG. 4A depicts a perspective view of a coupling member for the showerhead assembly depicted in FIG. 1.

FIG. 4B depicts another perspective view of the coupling member shown in FIG. 4B.

FIG. 5 depicts a perspective view of a coupling nut for the showerhead assembly depicted in FIG. 1.

FIG. 6A depicts a perspective view of a showerhead barrel for the showerhead assembly depicted in FIG. 1.

FIG. 6B depicts another perspective view of the showerhead barrel depicted in FIG. 6A.

FIG. 6C depicts a perspective view of a barrel cup seal for the showerhead barrel depicted in FIG. 6A.

FIG. 6D depicts another perspective view of the barrel cup seal depicted in FIG. 6C.

FIG. 6E depicts a perspective view of a mode indicator spring for the showerhead barrel depicted in FIG. 6A.

FIG. 6F depicts another perspective view of a mode indicator plunger depicted in FIG. 6E.

FIG. 6G depicts a perspective view showing an assembly of the showerhead barrel depicted in FIG. 6A, the barrel cup seal depicted in FIG. 6C, and the mode indicator plunger depicted in FIG. 6F.

FIG. 7A depicts a front perspective view of a showerhead nut for the showerhead assembly depicted in FIG. 1.

FIG. 7B depicts another perspective view of the showerhead nut depicted in FIG. 7A.

FIG. 8A depicts a perspective view of a showerhead flow director for the showerhead assembly depicted in FIG. 1.

FIG. 8B depicts another perspective view of the showerhead flow director depicted in FIG. 8A.

FIG. 9A depicts a showerhead face member for the showerhead assembly depicted in FIG. 1.

FIG. 9B depicts another perspective view of the showerhead face member depicted in FIG. 9A.

FIG. 10 depicts a perspective view of a showerhead cover for the showerhead assembly depicted in FIG. 1.

FIG. 11 depicts a schematic view of a diverter valve for use with a showerhead assembly.

FIG. 12 depicts an exploded perspective view of the components of the showerhead assembly depicted in FIG. 1.

FIG. 13 depicts a perspective view of a second example of a showerhead assembly with a conventional handheld showerhead attached to the showerhead assembly.

FIG. 14 depicts a partial cross-sectional view of the showerhead assembly depicted in FIG. 13, viewed along line 14-14.

FIG. 15 depicts a perspective view of a showerhead assembly depicted in FIG. 13 with the conventional handheld showerhead detached from the showerhead bracket.

FIG. 16 depicts a perspective view of a third example of a showerhead assembly with a conventional handheld showerhead attached to the showerhead assembly.

FIG. 17 depicts a cross-sectional view of the showerhead assembly depicted in FIG. 16, viewed along line 17-17 in FIG. 16.

FIG. 18 depicts an exploded perspective view of the components of the showerhead assembly depicted in FIG. 16.

FIG. 19 depicts a perspective view of a coupling member for the showerhead assembly depicted in FIG. 16.

FIG. 20 depicts another perspective view of the coupling member shown in FIG. 19.

FIG. 21 depicts a perspective view of a showerhead barrel for the showerhead assembly depicted in FIG. 16.

FIG. 22 depicts another perspective view of the showerhead barrel depicted in FIG. 21.

FIG. 23 depicts another perspective view of the showerhead barrel depicted in FIG. 21.

FIG. 24 depicts a perspective view of a showerhead flow director for the showerhead assembly depicted in FIG. 16.

FIG. 25 depicts another perspective view of the showerhead flow director depicted in FIG. 24.

FIG. 26 depicts a nozzle member for the showerhead assembly depicted in FIG. 16.

FIG. 27 depicts another perspective view of the nozzle member depicted in FIG. 26.

FIG. 28 depicts a perspective view of a showerhead cover for the showerhead assembly depicted in FIG. 16.

FIG. 29 depicts another perspective view of a showerhead cover depicted in FIG. 28.

### DETAILED DESCRIPTION

Described herein are various examples of a showerhead assembly. The showerhead assembly may include a showerhead bracket configured for attaching a conventional handheld showerhead in fluid communication with the showerhead assembly. A coupling member may join the showerhead assembly to a shower pipe, and a showerhead may be joined to the showerhead bracket to deliver water or other fluid from the showerhead assembly. The showerhead bracket may be selectively rotatable and/or pivotable relative to the coupling member, the showerhead, or both in order to change the direction water exits the showerhead assembly relative to the showerhead pipe.

The showerhead assembly may operate in one or more modes, which may include at least one off mode in which no water exits the showerhead. The operation mode for the showerhead assembly may be selected by rotating at least some components of the showerhead, such as a showerhead face cover, relative to the showerhead bracket. Some embodiments of the showerhead assembly may include a diverter valve to selectively control the flow of fluid from the showerhead pipe to the showerhead and a handheld showerhead in fluid communication with the such showerhead assemblies. The diverter valve may be controlled by rotating or otherwise moving some feature on the showerhead or showerhead bracket, such as a face ring, a control ring, a lever, and so on.

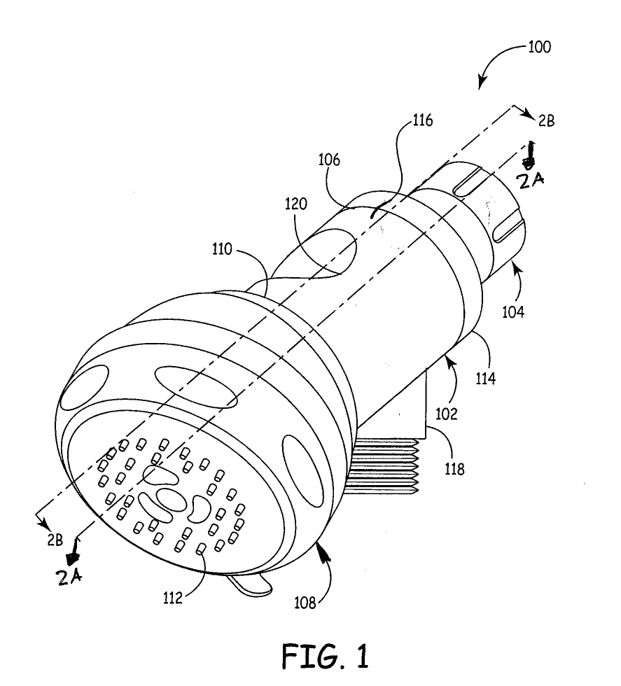

FIG. 1 depicts a perspective view of a first example of a showerhead assembly 100. The showerhead assembly 100 may include a showerhead bracket 102 joined to a coupling member 104 near its rear end portion 106 and to a showerhead 108 near its front end portion 110. The coupling member 104 may join the showerhead bracket 102 to a shower pipe or other water source. The coupling member 104 may be selectively rotatable, pivotable, or otherwise movable relative to the showerhead bracket 102. Such selective movement may allow a user to control the direction that a fluid exits the showerhead assembly 100 through the showerhead 108. The showerhead 108 may deliver water or other fluid from the showerhead assembly 100 via one or more showerhead nozzles 112. To allow a user to further control the direction that a fluid exits the showerhead 108, the showerhead 108 may be selectively pivotable relative to the showerhead bracket 102. The showerhead assembly 100 may further include a coupling nut 114 to secure the coupling member 104 to the showerhead bracket 102. The various components forming the showerhead bracket 102, the coupling member 104, the showerhead 108, and the coupling nut 114 may be made of plastic, metal, ceramic, any other suitable material, or any combination thereof.

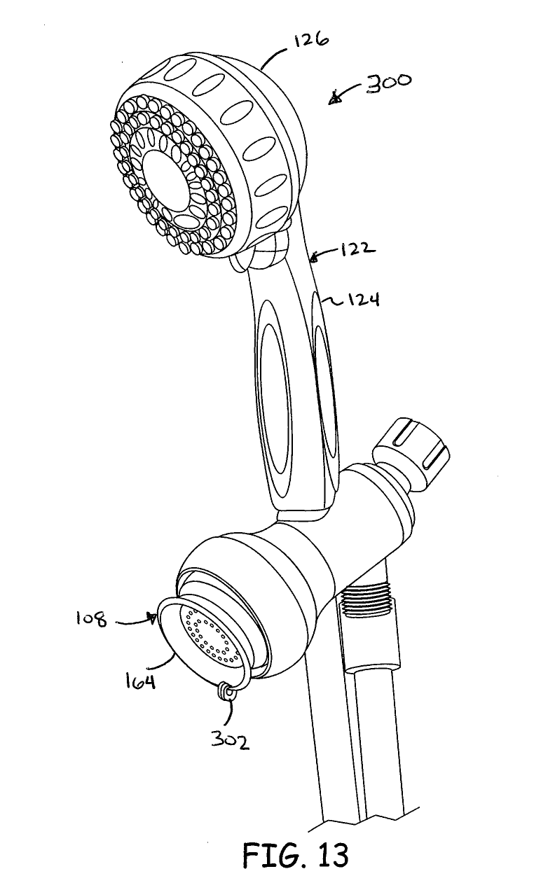

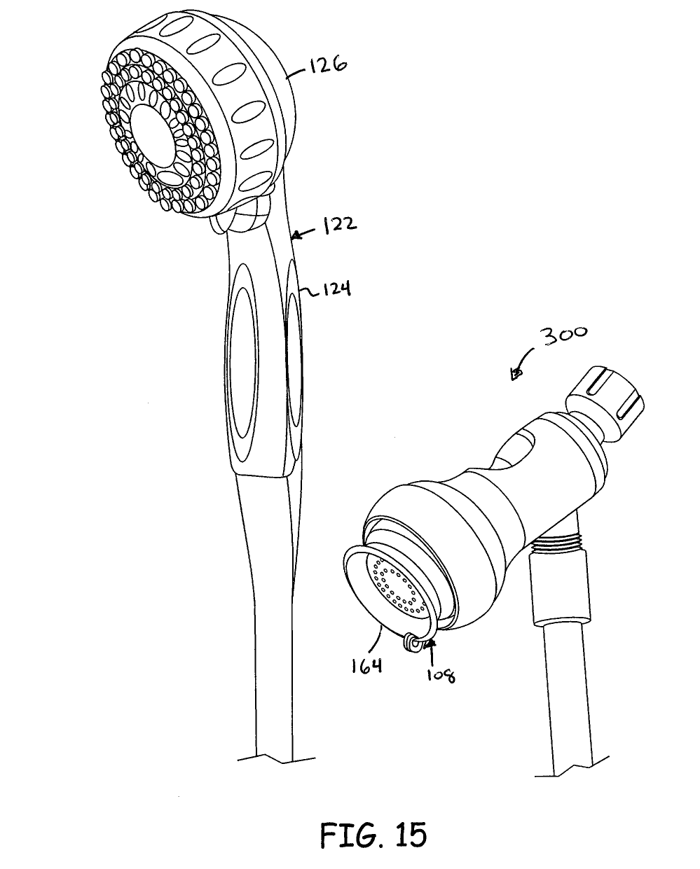

With reference to FIGS. 1, 2A, 2B, 3A and 3B, the showerhead bracket 102 may include a bracket body 116 and a fluid outlet port 118. The bracket body 116 may define a handheld showerhead slot 120, which may securely and releasably attach a handheld showerhead 122 to the showerhead bracket 102 (see, e.g., FIGS. 13 and 15). Generally, the handheld showerhead slot 120 receives a handle 124 of the handheld showerhead 122. However, any suitable portion of a handheld showerhead 122 (for example, the showerhead portion 126) may be received within the slot 120. The handheld showerhead slot 120 may securely retain a received handheld showerhead 122 within it until the handheld showerhead 122 is selectively removed from the slot 120. If desired, the handheld showerhead slot 120 may securely and releasably attach suitably sized items other than a handheld showerhead 122 to the showerhead bracket 102.

With continued reference to FIGS. 1, 2A, 2B, 3A and 3B, the handheld showerhead slot 120 is generally C-shaped in the present embodiment. In alternative embodiments, the slot 120 may take any other shape suitable for securely and releasably attaching a handheld showerhead 122 to the showerhead bracket 102. The handheld showerhead slot 120 may be located at any suitable location between the showerhead 108 and the coupling member 104. The handheld showerhead slot 120 may be stepped to form a ledge for a portion of the handheld showerhead 122, for example, a lower end of a handheld showerhead handle 124, to bear against.

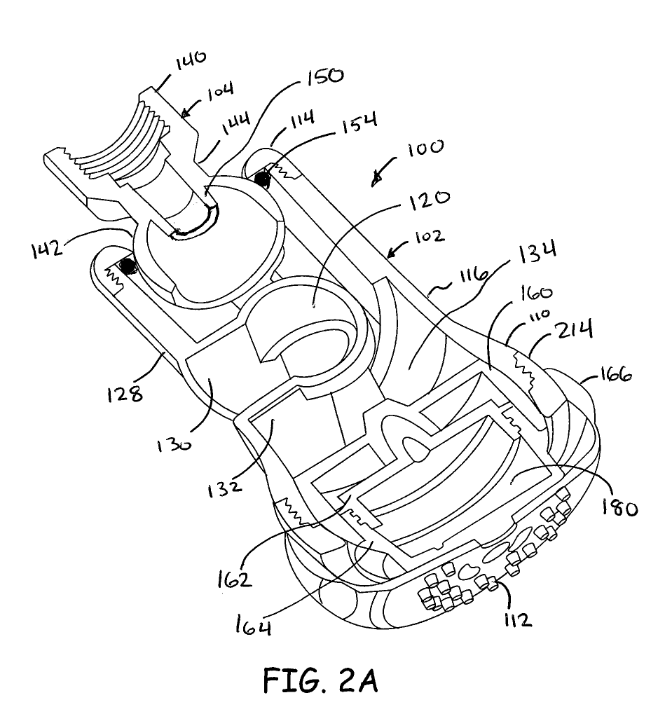

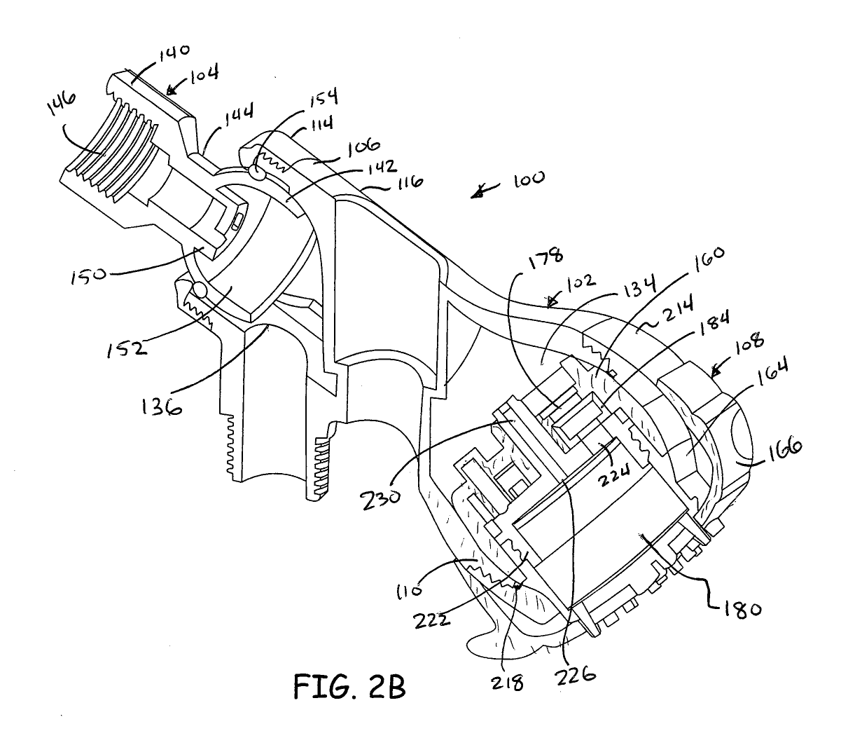

The handheld showerhead slot 120 may also be generally aligned with the showerhead 108 and the coupling member 104 along an longitudinal axis of the showerhead bracket 102 as best shown in FIG. 2A, or otherwise generally located inward compared to other external surface sections of the showerhead bracket 102. Aligning the handheld showerhead slot 120 along the showerhead bracket's longitudinal axis saves space when the handheld showerhead 122 is attached to the showerhead bracket 102 because at least a portion of the handheld showerhead 122 is inward of the showerhead bracket's exterior surface 128. Aligning the handheld showerhead slot 120 along the showerhead bracket's longitudinal axis also reduces or substantially eliminates the torsion moment applied by the handheld showerhead 122 around the showerhead bracket's longitudinal axis since the center of gravity of the handheld showerhead 122 is closer to the showerhead bracket's longitudinal axis. This may minimize the tendency for the showerhead assembly 100 to unscrew from the pipe because of unbalanced loads. Further, aligning the handheld showerhead slot 120 inward of the other external surface sections of the showerhead bracket 102 may provide an enhanced ability to design a showerhead bracket 102 with an aesthetically appealing shape and/or may enable the utilization of less material to create the showerhead bracket 102.

The bracket body 116 may define a pair of generally opposing and parallel sidewalls 130, 132 that extend from the handheld showerhead slot 120 to adjacent exterior surfaces of the bracket body 116. The sidewalls 130, 132 may provide ready access to the handheld showerhead slot 120 for receiving and removing a handheld showerhead 122 from the handheld showerhead slot 120.

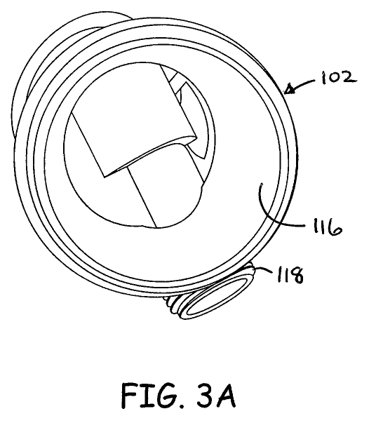

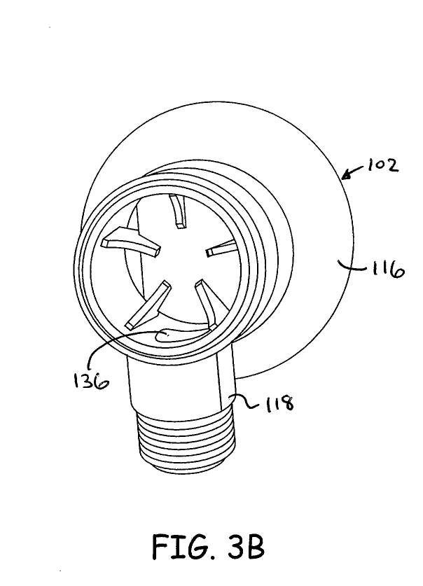

With reference to FIGS. 2A, 2B, 3A and 3B, the bracket body 116 may define a bracket fluid chamber 134 in fluid communication with the showerhead 108 and with the coupling member 104. With reference to FIG. 3B, a bracket fluid outlet 136 may be defined by the bracket body 116 between the showerhead 108 and the coupling member 104 as depicted, or at any other suitable location between the showerhead 108 and the coupling member 104. The bracket fluid outlet 136 may provide fluid communication between the bracket fluid outlet port 118 and the bracket fluid chamber 134. If desired, the bracket body 116 may have more or less than one bracket fluid outlet 136. Further, if the bracket body 116 has more than one bracket fluid outlet 136, any or all may be fluidly joined to a fluid inlet of a showerhead (handheld, mounted, or otherwise) or any other suitable fluid delivery device. Similarly, the showerhead bracket 102 may also have more or less than one bracket fluid outlet port 118.

Although not shown, the bracket fluid chamber 134 may be divided into two or more sections, if desired. These sections may form independent fluid flow paths between the bracket fluid chamber 134 and the showerhead 108 and between the bracket fluid chamber 134 and the bracket fluid outlet 136. Providing such separate flow paths may be useful to selectively allow fluid to flow to only the showerhead 108, to only the bracket fluid outlet 136, to both, or to neither by use of a diverter valve or other similar fluid control structure located within, or otherwise operably associated with, the showerhead bracket 102.

The fluid outlet port 118 may be generally cylindrical or any other desired shape. The fluid outlet port 118 may extend from the bracket body 116 upstream of the handheld showerhead slot 120 as depicted in, for example, FIGS. 1 and 2B, or at any other position between the showerhead 108 and the coupling member 104. The fluid outlet port 118 may provide fluid communication via the showerhead bracket 102 between the showerhead pipe and a handheld showerhead 122 (see, e.g., FIG. 13) or other fluid delivery device. At least a portion of the fluid outlet port's exterior surface, as shown in FIGS. 1 and 2B, or interior surface may be threaded. These threads may mate with a threaded connection attached to a hose, or other structure, that supplies fluid to a handheld showerhead 122 (or other fluid delivery device). Although threads are depicted for joining a hose (or other appropriate structure) to the fluid outlet port 118, the hose (or other appropriate structure) and the fluid outlet port 118 may be joined by press fitting, clamping, any other suitable connection method, or any combination thereof.

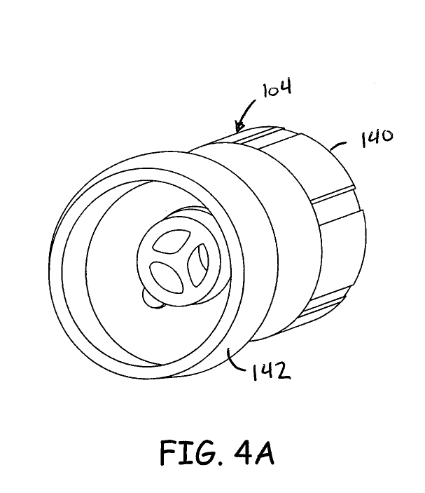

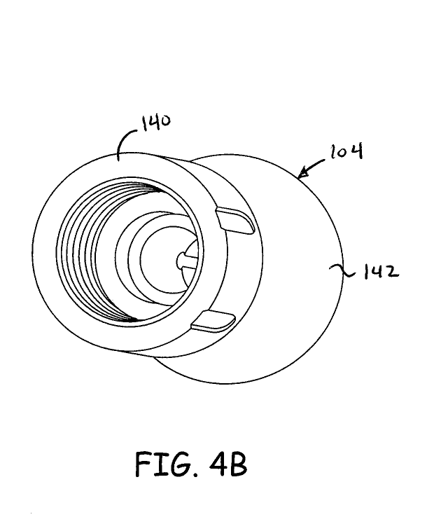

With reference to FIGS. 2A, 2B, 4A and 4B, the coupling member 104 may include a shower pipe section 140 connected to a ball joint section 142 via an intermediate section 144. The shower pipe section 140 may be generally cylindrical and may have an internal surface that defines a fluid passage. At least a portion of the shower pipe section 140 may be threaded. The threads may be internal as shown, for example, in FIG. 4B, or external. The threads may be configured to mate with corresponding threads on a shower pipe near its water outlet, or on another structure such as hose in fluid communication with a water outlet of a shower pipe, to mechanically join or otherwise associate the coupling member 104 with the shower pipe and to fluidly join the coupling member's fluid passage to the shower pipe's water outlet. Although the coupling member 104 is shown as threadedly joined to the shower pipe (or other appropriate structure), the coupling member 104 and the shower pipe may be joined by press fitting, clamping, any other suitable method, or any combination thereof. Near the coupling member's intermediate section 144, the shower pipe section's internal surface 146 may be stepped inwardly to define a narrower fluid passage for receiving an O-ring (not shown) or other suitable sealing member. The O-ring may form a fluid-tight seal between the shower pipe and the coupling member 104.

The coupling member's intermediate section 144 may be generally cylindrical and may have an interior surface that defines a fluid passage in fluid communication with the shower pipe section's fluid passage. A cylindrical sidewall 150 may extend from the intermediate section 144 into a ball joint fluid chamber 152 defined by the ball joint section 142. The sidewall's interior surface may define a fluid passage that fluidly connects the intermediate section's fluid passage with the ball joint fluid chamber 152.

The coupling member's ball joint section 142 may be sized for receipt within the showerhead bracket's fluid chamber 134 through a bracket rear opening defined by the showerhead bracket 102 near its rear end portion 106. Further, the ball joint section 142 may generally resemble a partial ball, which may facilitate selectively rotating and pivoting the coupling member 104 relative to the showerhead bracket 102. Further, a fluid path may be formed between a shower pipe's fluid outlet and the showerhead bracket's fluid chamber 134 via the fluid passages and chambers defined by the coupling member 104.

A cup seal (not shown), an O-ring 154 (see FIG. 2B), or other suitable sealing member may form a fluid tight seal between the coupling member 104 and the showerhead bracket 102. More particularly, the cup seal, O-ring 154, or other suitable sealing member may prevent fluid from leaking through the joints formed between the coupling member 104 and the coupling nut 114 and between the coupling nut 114 and the showerhead bracket 102. In lieu of or in combination with a sealing member, one or more abutting surfaces of the coupling member 104, the coupling nut 114, and the showerhead bracket 102 may be made of, or coated with, a resilient matter (e.g., rubber or other suitable material) to prevent fluid from leaking through the respective joints formed between them.

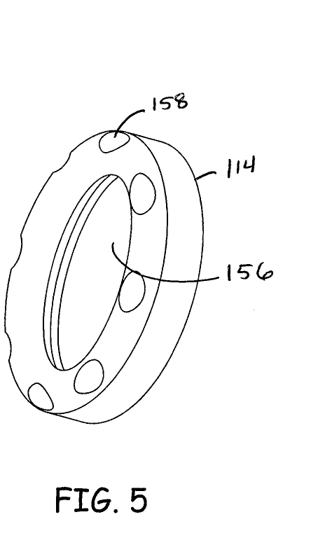

With reference to FIGS. 2A, 2B, and 5, the coupling nut 114 may be joined to the showerhead bracket 102 near the showerhead bracket's rear end portion 106 to retain at least a portion of the ball joint section 142 within the bracket fluid chamber 134. More particularly, the coupling nut 114 may have a coupling nut hole 156 sized to retain at least at portion of the ball joint section 142 within the bracket fluid chamber 134. The coupling nut hole 156 may be circular as depicted in FIG. 5 or any other suitable shape for retaining at least a portion of the ball joint section 142 within the bracket fluid chamber 134. The coupling nut 114 may be threadedly joined to the showerhead bracket 102 as shown in FIGS. 2A and 2B, or may be joined by press fitting, clamping, heat or sonic welding, or any other suitable method.

The coupling nut 114 may have one or more concave coupling nut indentations 158 on its exterior surface. The coupling nut indentations 158 may provide finger gripping surfaces to facilitate rotating the coupling nut 114 relative to the showerhead bracket 102 when threadedly attaching and detaching the coupling nut 114 and the showerhead bracket 102. In some embodiments, the coupling nut 114 may include two or more raised ribs or features, in lieu of or in combination with indentations 158, to facilitate gripping the coupling nut 114 by a user.

With reference to FIGS. 1, 2A and 2B, to allow a user to selectively control the direction of a fluid that exits the showerhead assembly 100 through the showerhead 108, the coupling member 104 may be selectively moved relative to the showerhead bracket 102, which may allow a user to selectively control the direction of a fluid that exits the showerhead 108. More particularly, since the coupling member's ball joint section 142 is not fixedly attached to either the coupling nut 114 or the showerhead bracket 102, the coupling member 104 may be selectively rotated and/or pivoted relative to the showerhead bracket 102. Further, the ball joint section's partially ball shaped structure may facilitate selectively rotating and pivoting the coupling member 104 relative to the showerhead bracket 102.

With reference to FIGS. 2A and 2B, the showerhead 108 for the first example of a showerhead assembly 100 may include a showerhead barrel 160, a showerhead flow director 162, a showerhead face member 164, and a showerhead cover 166. The showerhead flow director 162 may be selectively rotated relative to the showerhead barrel 160 using the showerhead cover 166 to select an operation mode for the showerhead 108. Using the showerhead cover 166, the assembled showerhead components may be selectively pivoted relative to the showerhead bracket 102 to change the coverage area of water or other fluid that exits the showerhead 108. The assembled showerhead 108, or its individual components, may also be easily changeable so that a user may readily change, replace or repair the assembled showerhead 108, or its individual components

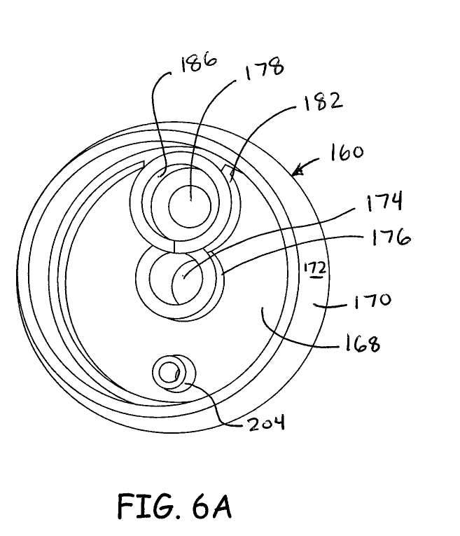

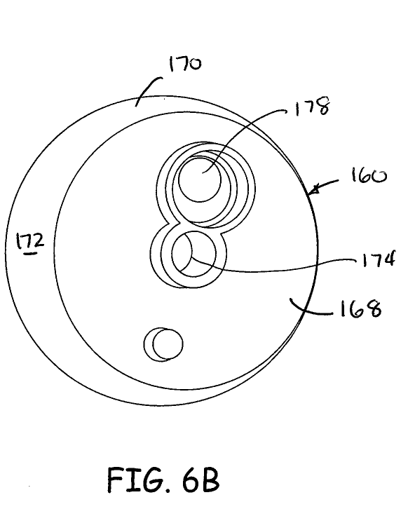

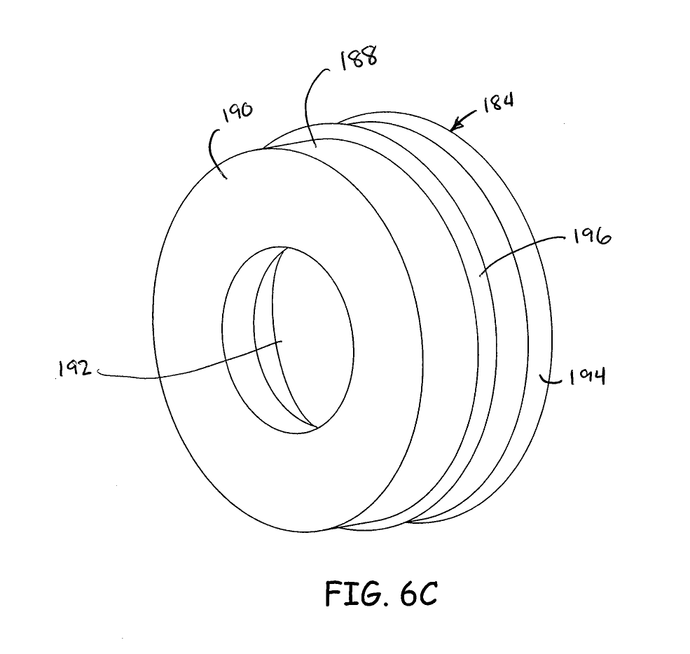

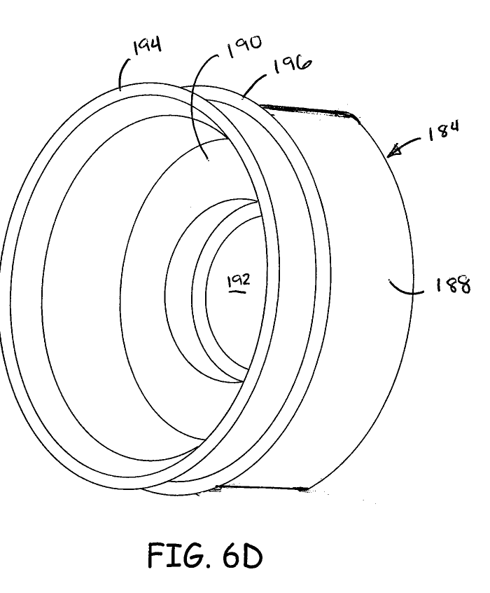

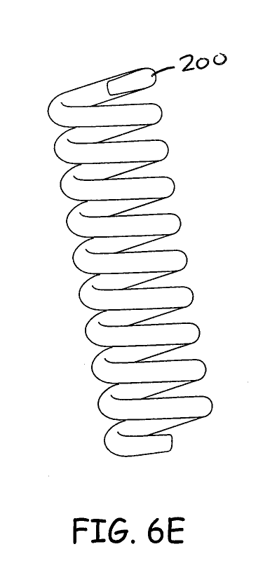

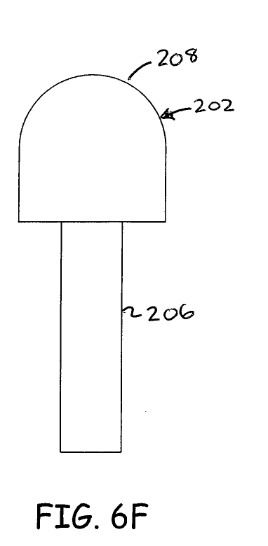

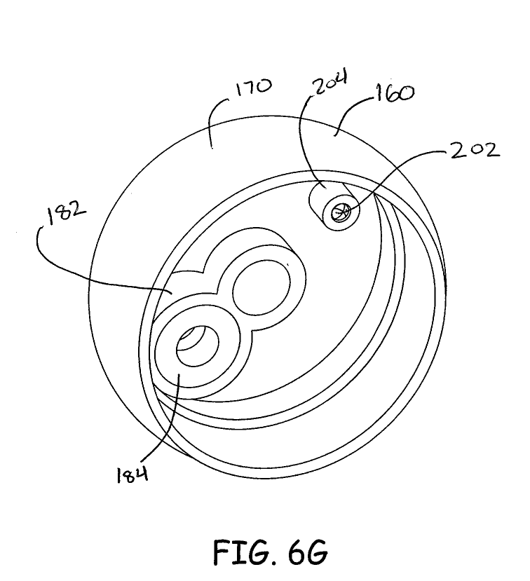

With reference to FIGS. 2A, 2B, 6A, and 6B, a portion of the showerhead barrel 160 may be received into the bracket fluid chamber 134 through a bracket front opening defined by the showerhead bracket 102 near the showerhead bracket's front end portion 110. The showerhead barrel 160 may include a showerhead barrel base 168 with a showerhead barrel wall 170 extending from the showerhead barrel base 168. The showerhead barrel wall 170 may have a generally partial spherical-shaped outer surface 172. Near the showerhead barrel base 168, a portion of the showerhead barrel wall outer surface 172 may generally complement a curved inner surface of the bracket body 116. These complementary surfaces allow the showerhead barrel 160 to be selectively pivoted relative to the showerhead bracket 102.

A showerhead barrel connection opening 174 may be formed in the showerhead barrel base 168. The showerhead barrel connection opening 174 may receive a fastener (not shown) for joining the showerhead barrel 160 to the showerhead flow director 162. A generally cylindrical barrel connection wall 176 that encompasses the showerhead barrel connection opening 174 may extend from both sides of the showerhead barrel base 168.

The showerhead barrel base 168 may define a showerhead barrel fluid opening 178. The showerhead barrel fluid opening 178 in conjunction with a fluid opening in the showerhead flow director 162 may selectively permit and prevent fluid communication between the bracket fluid chamber 134 and a showerhead fluid chamber 180 as described in more detail below. A generally cylindrical barrel fluid wall 182 that encompasses the showerhead barrel fluid opening 178 may extend from both sides of the showerhead barrel base 168.

Turning to FIGS. 2A, 2B, and 6A-6D, a barrel cup seal 184 may be received within the space defined by the barrel fluid wall's inner surface 186 for forming a fluid seal between the showerhead barrel 160 and the showerhead flow director 162. The barrel cup seal 184 may be made of rubber or other suitable material and may include a barrel cup seal wall 188 extending from a barrel cup seal base 190. The barrel cup seal base 190 may include a barrel cup seal fluid hole 192 for allowing fluid to enter the showerhead fluid chamber 180 from the bracket fluid chamber 134. A barrel cup seal lip 194 may extend in an outward slope from the barrel cup seal wall 188 for forming a fluid seal with the showerhead barrel 160 and for biasing the barrel cup seal base 190 against the showerhead flow director 162. More particularly, as best shown in FIG. 6G, the barrel cup seal base 190 extends slightly beyond the barrel fluid wall 182. When the showerhead flow director 162 and showerhead barrel 160 are joined, the showerhead flow director 162 presses against the barrel cup seal 184 and moves it towards the showerhead barrel 160. As the barrel cup seal 184 moves towards the showerhead barrel 160, the barrel cup seal lip 194 engages the showerhead barrel base 190. The barrel cup seal lip's engagement with the showerhead barrel 160 forms a fluid seal between the barrel cup seal 184 and the showerhead barrel 160 and biases the barrel cup seal base 190 against the showerhead flow director 162.

With reference to FIGS. 6A-6D, an annular barrel cup seal ring 196 that extends outwardly from the barrel cup seal wall 188 may provide an additional fluid seal between the barrel cup seal 188 and the showerhead barrel 160. This seal may be enhanced when fluid is contained within the barrel cup fluid seal space defined by the barrel cup seal base 190 and the barrel cup seal wall 188. More particularly, fluid pressure from fluid contained within the barrel cup seal fluid space may push outwardly on the barrel cup seal wall 188, thereby pressing the barrel cup seal ring 196 against the showerhead barrel fluid wall 182. As the barrel cup seal ring 196 is pressed against the showerhead barrel fluid wall 182, the fluid seal between the showerhead barrel 160 and the barrel cup seal 184 may be enhanced.

Turning to FIGS. 6A, 6B, and 6E-6G, a mode indicator may provide an indication to a user when a showerhead mode is successfully selected by the user. The mode indicator may include a mode indicator spring 200 and a mode indicator plunger 202 received within a generally cylindrical mode indicator wall 204 extending from the showerhead barrel base 168, or may be any other suitable structure or assembly of components that provide a means for providing an indication to a user that a showerhead operating mode has been successfully selected. The mode indicator wall 204 may extend from the showerhead barrel base 168 in generally the same direction as the showerhead barrel wall 170 and may limit relative rotation between the showerhead barrel 160 and the showerhead flow director 162 as described in more detail below.

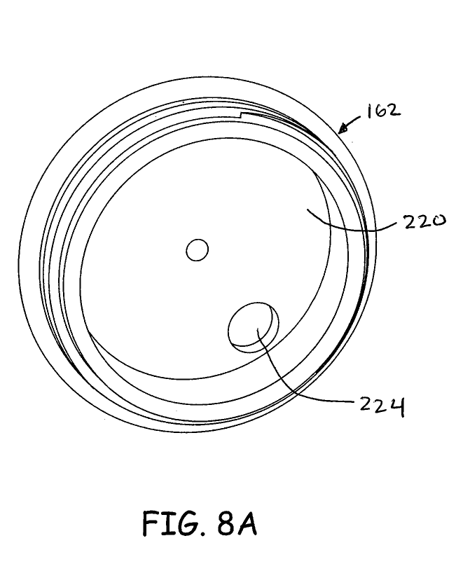

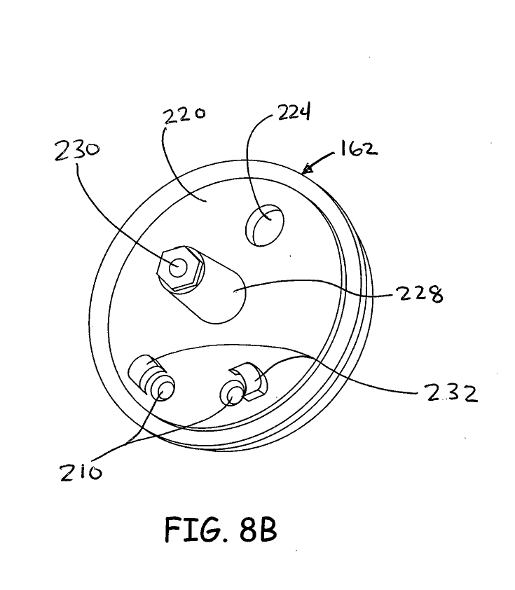

The mode indicator plunger 202 may include a generally cylindrical plunger shaft 206 for receiving the mode indicator spring 200 thereon. Near an end of the plunger shaft 206, the mode indicator plunger 202 may include a plunger tip 208, which may be received within mode indicator holes 210 (see FIG. 8B) defined in the showerhead flow director 162 as described in more detail below. The plunger tip 208 may include a generally cylindrical section that ends with a partially spherical section or may be any other suitable shape. As depicted in 6F, the plunger tip's cylindrical section may have a diameter that is generally larger than the plunger shaft's diameter.

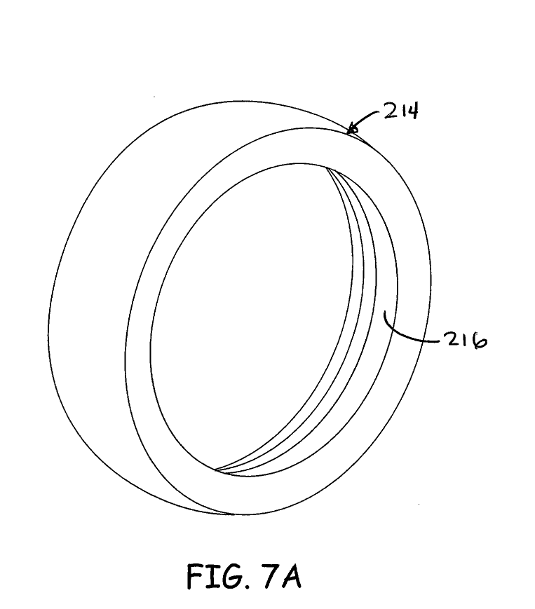

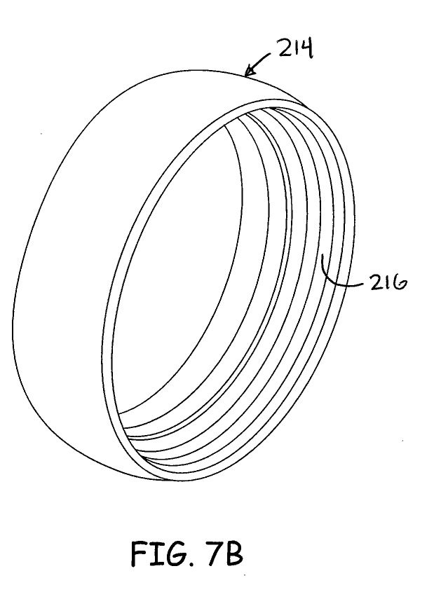

With reference to FIGS. 2A, 2B, 7A and 7B, a showerhead nut 214 joined with the showerhead bracket 102 may retain the showerhead barrel 160 within the bracket fluid chamber 134. The showerhead nut 214 may be joined with threads to the showerhead bracket 102 as depicted or may be joined by press fitting, clamping, or any other suitable method. A portion of the showerhead nut's inner surface 216 may be curved to generally complement a portion of the showerhead barrel's curved outer surface. These complementary curved surfaces allow the showerhead barrel 160 to be selectively pivoted relative to the showerhead nut 214. The showerhead nut's inner surface 216 may also be stepped to define in conjunction with the showerhead bracket 102 and the showerhead barrel 160 a front end cavity 218 that encompasses the showerhead bracket's front opening. An O-ring (not shown) or other suitable sealing member may be received in the front end cavity 218 to prevent fluid leakage from the bracket fluid chamber 134 through the joints formed between the showerhead barrel 160, the showerhead bracket 102, and the showerhead nut 214. In lieu of or in combination with a sealing member, one or more abutting surfaces of the showerhead barrel 160, the showerhead bracket 102, and the showerhead nut 214 may be made of or coated with a resilient matter (e.g., rubber or other suitable material) to prevent fluid from leaking through the respective joints formed between them.

With reference to FIGS. 2A, 2B, 8A and 8B, the showerhead flow director 162 may include a flow director base 220 with a flow director wall 222 extending from the flow director base 220. Together, the flow director base 220 and the flow director wall 222 may define a portion of the showerhead fluid chamber 180. At least a portion of the flow director wall's outer surface, as shown in the figures, or inner surface may be threaded for joining the showerhead flow director 162 to the showerhead face member 164.

A flow director fluid opening 224 may be defined in the flow director base 220. When the flow director fluid opening 224 aligns with the showerhead barrel fluid opening 178, fluid may flow from the bracket fluid chamber 134 into the showerhead fluid chamber 180 defined by the showerhead flow director 162 and the showerhead face member 164. From the showerhead fluid chamber 180, fluid may then flow out of the showerhead 108 through the showerhead nozzles 112 formed in the showerhead face member 164. When the openings 178, 224 are not generally aligned, fluid flow from the bracket fluid chamber 134 to the showerhead fluid chamber 180 is prevented, thereby effectively stopping the flow of fluid through the showerhead nozzles 112. These openings 178, 224 may be selectively aligned and not aligned by rotating the showerhead flow director 162 relative to the showerhead barrel 160. The openings 178, 224 may be oriented to direct the flow of water to exit tangentially from them. For an embodiment containing a turbine within the showerhead 108, a tangential water flow may cause the turbine to rotate to deliver a pulsating spray from the showerhead 108.

The flow director base 220 may also define a flow director fastener opening 226. The flow director fastener opening 226 may receive a fastener (not shown) for joining the showerhead barrel 160 to the showerhead flow director 162. More particularly, a flow director shaft 228 may encompass the flow director fastener opening 226 and may extend from the flow director base's rearward facing surface. The flow director shaft 228 may define a fastener passage 230 that extends from the flow director fastener opening 226 to the flow director shaft's free end. The fastener passage 230 may receive the fastener that joins the flow director 162 to the showerhead barrel 160. More particularly, the flow director shaft 228 is received within the showerhead barrel connection opening 174 of the showerhead barrel 160. The fastener received within the flow director shaft's fastener passage 230 is then suitably joined to either the showerhead barrel 160, or other device such as a nut, to join the showerhead flow director 162 to the showerhead barrel 160. The fastener and its associated joining mechanism may be configured to allow the showerhead flow director 162 to be selectively rotated relative to the showerhead barrel 160. If desired, an O-ring (not shown), cup seal, or other suitable seal member may be used in conjunction with one or more of the flow director shaft 228, the barrel connection wall 176, and the fastener to prevent fluid leaks between the bracket fluid chamber 134 and the showerhead fluid chamber 180 through the joints formed by between the flow director shaft 228, the barrel connection wall 176, and the fastener. In lieu of or in combination with a sealing member, one or more abutting surfaces of the flow director shaft 228, the barrel connection wall 176, and the fastener may be made of or coated with a resilient matter (e.g., rubber or other suitable material) to prevent fluid from leaking through the respective joints formed between them.

Because the flow director 162 may be rotated relative to the showerhead barrel 160, the flow director fluid opening's 224 position relative to the showerhead barrel fluid opening 178 may be selectively adjusted. More particularly, the flow director fluid opening 224 may be selectively aligned with the showerhead barrel fluid opening 178 (and the barrel cup seal fluid hole 192 which is coaxially aligned with the showerhead barrel fluid opening 178 as best shown in FIG. 6G) by rotating the flow director 162 relative to the showerhead barrel 160, thereby allowing fluid to enter the showerhead fluid chamber 180 from the bracket fluid chamber 134 when the openings 178, 224 are aligned. Once fluid enters the showerhead fluid chamber 180, it may exit the showerhead 108 through the showerhead nozzles 112. The flow director fluid opening 224 may also be selectively not aligned with the showerhead barrel fluid opening 178 by rotating the flow director disk 162 relative to the showerhead barrel 160, thereby preventing fluid from entering the showerhead fluid chamber 180 from the bracket fluid chamber 134. When not aligned, the barrel cup seal fluid hole 192 does not align with the flow director fluid opening 224, thereby providing a fluid seal between the showerhead barrel 160 and the showerhead flow director 162 and stopping fluid flow between the showerhead fluid chamber 180 and the bracket fluid chamber 134. Once fluid cannot enter the showerhead fluid chamber 180, fluid flow from the showerhead 108 ceases.

Mode indicator stops 232 may extend from the flow director base's rearward facing surface as shown, for example, in FIG. 8B. These mode indicator stops 232 may limit the range of rotation of the showerhead flow director 162 relative to the showerhead barrel 160. More particularly, the mode indicator wall 204 may be received between these indicator stops 232. As the showerhead flow director 162 is rotated relative to the showerhead barrel 160, the mode indicator wall 204 moves relative to the showerhead flow director disk 162. As the mode indicator wall 204 moves relative to the showerhead flow director 162, it will eventually contact one of a mode indicator stops 232, thereby preventing further rotation of the showerhead flow director 162 relative to the showerhead barrel 160. Then, as the showerhead flow director 162 is rotated relative to the showerhead barrel 160 in an opposite direction, the mode indicator wall 204 will move relative to the showerhead flow director 162 in this opposite direction until it contacts the other mode indicator stop 232, thereby limiting further rotation of the showerhead flow director 162 relative to the showerhead barrel 160 in this other direction. Thus, rotation of the showerhead barrel 160 relative to the showerhead flow director 162 may be limited to the distance between the mode indicator stops 232.

Two mode indicator holes 210 formed in the flow director base's rearward facing surface may be located near the mode indicator stops 232. Further, the mode indicator holes 210 may be generally arranged to indicate, in conjunction with the mode indicator plunger 202, whether the fluid openings in the showerhead flow director 162 and the showerhead barrel 160 are aligned. Specifically, each mode indicator hole 210 receives the mode indicator plunger tip 208 when the mode indicator wall 204 is generally aligned above it. More particularly, when the mode indicator wall 204 generally aligns over a mode indicator hole 210, the mode indicator spring 200 biases the mode indicator plunger tip 208 into the hole 210. Each mode indicator hole 210 may have a wall that slopes inwardly from the flow director base's rear facing surface to facilitate moving the mode indicator plunger tip 208 towards the showerhead barrel 160 as a user rotates the mode indicator wall 204 away from the mode indicator hole 210 that received the mode indicator plunger tip 208.

The mode indicator wall 204 and the mode indicator holes 210 are arranged on their respective showerhead components such that when the mode indicator plunger 202 is received in one of the mode indicator holes 210, the fluid openings 178, 224 in the showerhead flow director 162 and the showerhead barrel 160 are aligned, and when the mode indicator plunger 202 is received in the other mode indicator hole 210, the fluid openings 178, 224 in the showerhead flow director 162 and the showerhead barrel are not aligned 160. Thus, receipt of the mode indicator plunger 202 in one of the mode indicator holes 210 provides a tactile and/or audio indication of when a mode for the showerhead 108 is selected by the user. Although two mode indicator holes 210 are depicted and described, more than two indicator holes 210 may be used. For example, three mode indicator holes suitably arranged with respect to the mode indicator wall could be used for a showerhead with three modes of operation, one for each mode. Additionally, the mode indicator wall may be formed on the showerhead flow director and the mode indicator holes and stops may be formed on the showerhead barrel, if desired.

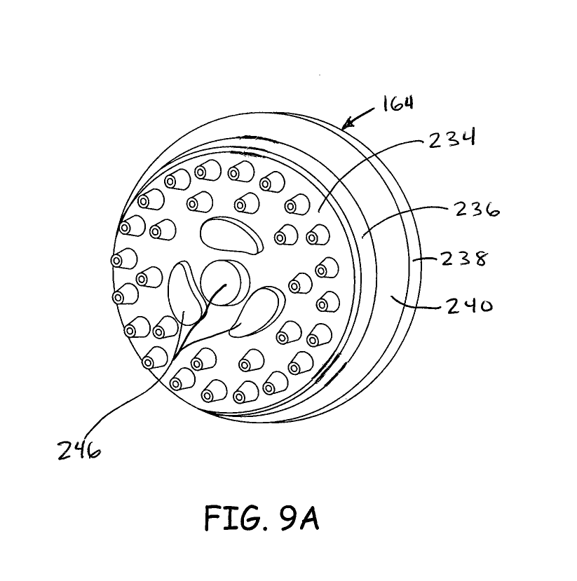

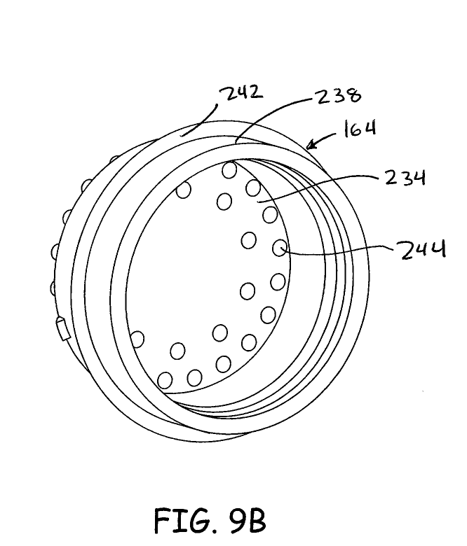

As shown in FIGS. 2A, 2B, 9A and 9B, the showerhead face member 164 may include a face member base 234. An upper face member wall 236 may extend from the face member base's rear facing surface and may be joined to a lower face member wall 238 by a face member flange 240. Together, the face member base 234 and the upper and lower face member walls 236, 238 define a portion of the showerhead fluid chamber 180.

The face member flange 240 may extend outwardly from the upper face member wall 236. The outer surfaces of the lower face member wall 238 and the face member flange 240 together define a lip 242 that may abut the showerhead barrel wall's front facing surface as shown in FIG. 2A. Such abutment may provide a visual or physical indication of when the showerhead face member 164 and showerhead flow director 162 are joined. The lower face member wall 238 may be received within a space defined by the showerhead barrel wall 170. At least a portion of the lower face member wall's interior surface as shown in the figures, or its exterior surface, may be threaded. These threads may mate with threads on the showerhead flow director 162, thereby enabling the showerhead flow director 162 to be threadedly joined with the showerhead face member 164. Although shown as being threadedly joined, the showerhead flow director 162 and the showerhead face member 164 may be joined by other suitable methods such as by press fit, heat or sonic welds, adhesives, and so on. When joined, the face member 164 and the flow director 162 together define the showerhead fluid chamber 180.

The showerhead fluid chamber 180 may be in fluid communication with the showerhead nozzles 112, which may extend from the face member base's front facing surface. The number and the arrangement of the showerhead nozzles 112 may be selected to create an aesthetically appealing design, to generally match the nozzle design of a handheld showerhead coupled with the showerhead bracket 102, or both. Nozzle openings 244 defined in the face member base 234 provide fluid communication between the showerhead nozzles 112 and the showerhead fluid chamber 180. If desired, face member projections 246 may extend from the face member base's front facing surface to create an aesthetically appealing design, to match similar features on a handheld showerhead coupled to the showerhead bracket, or both. The face member projections 246 may be teardrop and circular shaped as depicted or any other suitable shape, and may be arranged on the showerhead face member base's front facing surface as depicted, or arranged in any other aesthetically appealing or other desired manner. The face member projections 246 may also facilitate transmitting rotational and pivotal movement from the showerhead cover 166 to the showerhead face member 164.

Although not shown, the showerhead fluid chamber 180 may be divided into two or more sections, if desired. Each section may define independent flow paths to one or more showerhead nozzles 112, which may allow the showerhead 108 to operate in more than the two modes (on and off) previously described. Further, additional fluid openings in the showerhead flow director 162, the showerhead barrel 160, or both, may be configured to allow or prevent fluid flow from the bracket fluid chamber 134 to each flow path depending upon the relative rotational positions of the showerhead barrel 160 and the showerhead flow director 162, thereby allowing a user to select a showerhead mode by rotating the showerhead flow director 162 relative to the showerhead barrel 160.

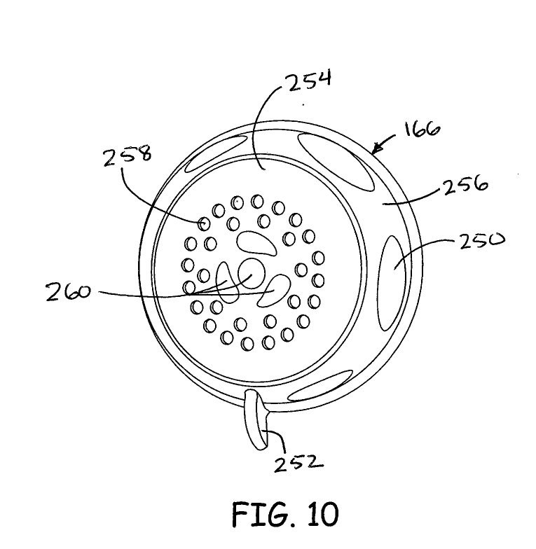

With reference to FIGS. 1, 2A, 2B and 10, the showerhead cover 166 may include one or more concave showerhead indentations 250 arranged around its axis of rotation as shown, for example, in FIGS. 1 and 10. These showerhead indentations 250 may provide a recessed surface for a user's fingers to grip to facilitate rotation of the showerhead cover 166 relative to the showerhead bracket 102 by the user. Additionally, a showerhead tab 252 may extend from the showerhead cover 166 to provide a structure for a user's fingers to grip to facilitate rotation of the showerhead cover 166 relative to the showerhead bracket 102 by the user.

The showerhead cover 166 may include a showerhead cover base 254 with a showerhead cover wall 256 extending from the showerhead cover base's rear facing surface. The showerhead cover wall's interior surface may snuggly and releasably engage the showerhead nut's outer surface by press fitting the showerhead cover 166 onto the showerhead nut 214. When engaged, the showerhead cover 166 may be selectively rotated and pivoted relative to the showerhead nut 214.

Press fitting the showerhead cover 166 onto the showerhead nut 214 makes it relatively easy to remove the showerhead cover 166 from the showerhead nut 214. Such removal may be desired to replace the showerhead cover 166 with another showerhead cover 166 and/or to access the other showerhead components. Further, using a threaded showerhead nut 214 makes it relatively easy to remove the showerhead nut 214 from the showerhead bracket 102 to further access the showerhead components. After disengaging the showerhead nut 214 from the showerhead bracket 102, showerhead components such as the showerhead face member 164, showerhead flow director 162, and showerhead barrel 160 may be readily removed from the showerhead bracket 102 to replace the showerhead 108 with another showerhead or to replace or repair individual showerhead components. Thus, the showerhead components may be designed to facilitate repairing or replacing the showerhead 108 or its individual components.

Showerhead cover nozzle openings 258 that correspond to the showerhead face member's showerhead nozzles 112 may be defined in the showerhead cover base 254. Additionally, showerhead cover openings 260 that correspond to the showerhead face member projections 246 may be defined in the showerhead cover base 254. When the showerhead cover 166 is joined with the showerhead face member 164, each showerhead nozzle 112 may be received through a corresponding showerhead cover nozzle opening 258, and each face member projection 246 may be received through a corresponding showerhead cover opening 260. Together, the face member projections 246, the showerhead nozzles 112, and the showerhead cover 166 may create an aesthetically appealing showerhead 108. Other aesthetically appealing features may also be incorporated into the showerhead cover 166, the showerhead face member 164, or both.

If desired, the face member projections 246 and their corresponding showerhead cover openings 260 may be sized to provide engagement surfaces between the showerhead cover 166 and the showerhead face member 164 such that rotation of the showerhead cover 166 relative to the showerhead bracket 102 causes rotation of the showerhead face member 164. In lieu of or in combination with sizing the face member projections 246 and their corresponding showerhead cover openings 260 to transmit rotation from the showerhead cover 166 to the showerhead face member 164, the showerhead cover 166 may be joined to the showerhead face member 164 using snaps, adhesives, mechanical fasteners, sonic welding, chemical bonding, any other suitable joining method, or any combination thereof. Rotation of the showerhead face member 164 in turn causes rotation of the showerhead flow director 162 relative to the showerhead barrel 160, thereby allowing a user to select a mode of operation for the showerhead 108 by rotating the showerhead cover 166 relative to the showerhead bracket 102. More particularly, rotation of the showerhead flow director 162 relative to the showerhead barrel 160 changes the relative location of the flow director fluid opening 224 to the showerhead barrel fluid 224 opening 178 thereby changing the operation mode of the showerhead 108.

If desired, the face member projections 246 and their corresponding face cover openings 260 may be sized to provide engagement surfaces that transmit pivotal movement of the showerhead cover 166 relative the showerhead bracket 102 to the showerhead face member 164. In lieu of or in combination with sizing the face member projections 246 and their corresponding face cover openings 260 to transmit pivotal articulation from the showerhead cover 166 to the showerhead face member 164, the showerhead cover 166 may be joined to the showerhead face member 164 using snaps, adhesives, mechanical fasteners, sonic welding, chemical bonding, any other known joining method, or any combination thereof. Pivoting the showerhead face member 164 by pivoting the showerhead cover 166 in turn causes pivoting of the showerhead flow director 162 relative to the showerhead bracket 102, which in turn cause the showerhead barrel 160 to pivot relative to the showerhead bracket 102. In other words, when a user selectively pivots the showerhead cover 166 relative to the showerhead bracket 102, this pivoting movement is transmitted to the other components of the showerhead 108 (i.e., the showerhead barrel 160, the flow director 162, and the showerhead face member 164), thereby resulting in the showerhead 108 pivoting relative to the showerhead bracket 102.

Since the showerhead 108 may be pivoted relative to the showerhead bracket 102, the direction that fluid spray exits the showerhead 108 may be selectively changed by a user. Further, the direction that fluid spray exits from the showerhead 108 may also be selectively changed by selectively pivoting the showerhead bracket 102 relative to the coupling member 104. These two ways for changing the direction that fluid spray exits from the showerhead 108 provide a wide range of potential directions for fluid spray from the showerhead 108 to be directed by a user.

With reference to FIGS. 2A and 2B, the showerhead nut's outer surface may be spherically concentric with the showerhead barrel's outer surface. The showerhead cover base's rear facing surface may also be concentric to the showerhead nut's outer surface and the showerhead barrel's outer surface. This concentric arrangement helps to maintain a relatively constant gap between the showerhead cover 166 and the showerhead bracket 102 when the showerhead 108 is pivoted relative to the showerhead bracket 102.

The showerhead 108 may be configured to automatically return to an off mode (or to another mode) when fluid pressure is removed from the showerhead 108. As an example, a spring (not shown) or other suitable resilient element may be used in the showerhead 108 and/or the showerhead bracket 102 to bias the relative rotational position of the showerhead flow director 162 to the showerhead barrel 160 to a certain default position in the absence of fluid pressure. Continuing with the example, the spring may bias the showerhead flow director 162 relative to the showerhead barrel 160 such that the flow director fluid opening 224 does not align with the showerhead barrel fluid opening 178 when there is no fluid pressure. In other words, the spring biases the showerhead 108 into a default off mode in the absence of fluid pressure. However, when fluid pressure is present, the showerhead 108 remains in the mode selected by the user (including the off mode) until the fluid pressure is removed or the user selects another mode. Although the example describes the showerhead 108 as returning to an off mode, the showerhead 108 may be configured to return to any of its modes in the absence of fluid pressure. Further, a system and/or a suitably modified system as described in U.S. Patent Publication No. 2005/0098485, which is hereby incorporated herein by reference in its entirety, or any other known system for biasing the operation mode of a faucet, showerhead, or the like to a default mode may be used.

Operation of the first example of the showerhead assembly 100 will now be described with reference to FIGS. 1, 2A, 2B, 6A and 8A. The showerhead bracket 102 may be attached to a shower pipe using the coupling member 104 to provide fluid communication between the shower pipe and the bracket 102. Water may then flow from the showerhead pipe to the bracket fluid chamber 134 through the coupling member 104. From the bracket fluid chamber 134, water may flow to the handheld showerhead through the bracket fluid outlet 136. Water may also flow from the bracket fluid chamber 134 into the showerhead fluid chamber 180 and then out of the showerhead 108 through the showerhead nozzles 112 when the flow director fluid opening 224 aligns with the showerhead barrel fluid 178 opening. To align these openings 178, 224, the showerhead cover 166 is rotated relative to the showerhead bracket 102 to its “on” position. Rotation of the showerhead cover 166 to its “on” position causes the showerhead flow director 162 to rotate to a position relative the showerhead barrel 160 where the flow director fluid opening 224 aligns with the showerhead barrel fluid opening 178. To stop water flow through the showerhead nozzles 112, the showerhead cover 166 is rotated relative to the showerhead bracket 102 to its “off” position. Rotation of the showerhead cover 166 causes the flow director 162 to rotate to a position relative the showerhead barrel 160 where the flow director fluid opening 224 does not align with the showerhead barrel fluid opening 178. When these openings 178, 224 are not aligned, fluid communication between the bracket fluid chamber 134 and the showerhead fluid chamber 180 ceases, thereby stopping the flow of water from the showerhead 108 through the showerhead nozzles 112. To change the general direction that water exits the showerhead 108, the showerhead bracket 102 may be pivoted relative to the showerhead 108, the coupling member 104, or both.

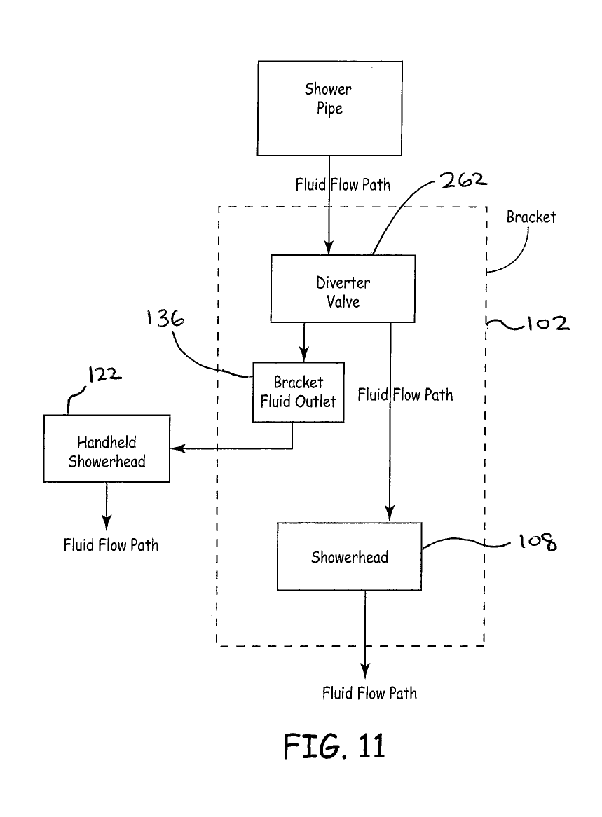

With reference to FIG. 11, a diverter valve 262 may be located upstream of the bracket fluid outlet 136 to control fluid flow from shower pipe to the showerhead 108 and the handheld showerhead 122. More particularly, fluid flows from the shower pipe to the diverter valve 262. After reaching the diverter valve 262, the diverter valve 262 may be selectively controlled by a user to allow fluid to flow to only the showerhead 108, to only the handheld showerhead 122, to both the showerhead 108 and the handheld showerhead 122, or to neither the showerhead 108 nor the handheld showerhead 122. The diverter valve 262 may be controlled by rotating or otherwise moving some feature on the showerhead 108 or showerhead bracket 102, such as a face ring, a control ring, a lever, and so on. Diverter valves as described in U.S. Pat. Nos. 6,230,989, 6,454,186 and 6,739,523, which are hereby incorporated herein by reference in their entirety, or any other suitable diverter valve or diverter valve system may be used.

When a diverter valve 262 is used to control whether fluid flows from the shower pipe to the showerhead 108, an off mode for the showerhead 108 may also be provided so that a user may stop the flow of fluid through the showerhead 108 using the diverter valve 262 or by rotating the showerhead cover 166 to its off mode position. However, providing an off mode by rotation of the showerhead 108 relative to the showerhead bracket 102 is not required. Further, it may be useful not to have an off mode for the showerhead 108 via rotation of the showerhead 108 relative to the showerhead bracket 102 to minimize the number of valves that a user must remember to open to obtain fluid flow out of the showerhead 108.

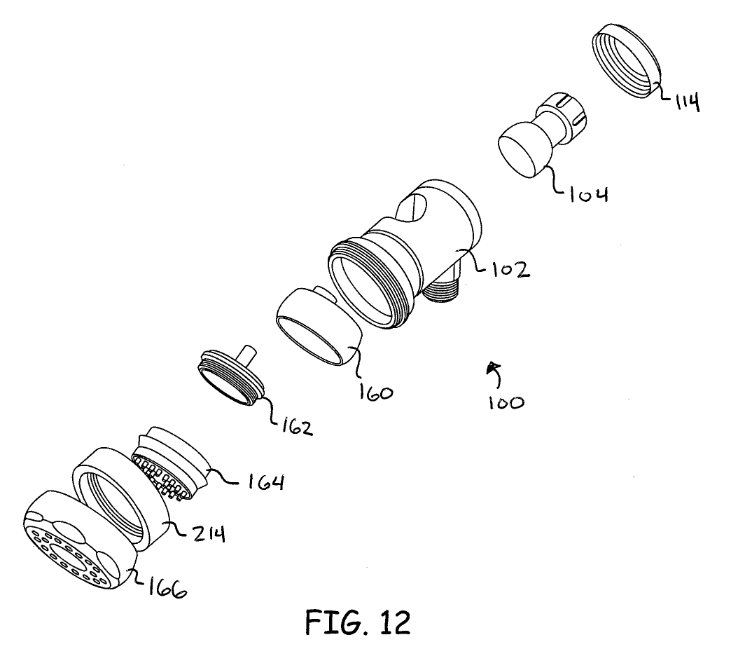

With reference to FIGS. 2A, 2B and 12, one method of assembling the first example of the showerhead assembly 100 is as follows. The ball joint section 142 of the coupling member 104 is placed within the bracket fluid chamber 134 through the showerhead bracket's rear opening, and the coupling nut 114 is threadedly joined to the showerhead bracket 102 to retain the connection between the coupling member 104 and the showerhead bracket 102. The showerhead flow director 162 is joined with the showerhead barrel 160 using a fastener (not shown). After joining the showerhead flow director 162 to the showerhead barrel 160, the showerhead face member 164 is joined with the showerhead flow director 162. These assembled showerhead components are placed within the showerhead bracket front opening. The showerhead nut 214 is joined to the showerhead bracket 102, thereby maintaining the connection of the showerhead 108 with the showerhead bracket 102. The showerhead cover 166 is pressed onto the showerhead nut 214, thereby completing assembly of the showerhead assembly 100. Although one way to assemble the components of the first example of the showerhead assembly 100 has been described, the components may be assembled in a different order and/or certain described steps may be modified or eliminated.

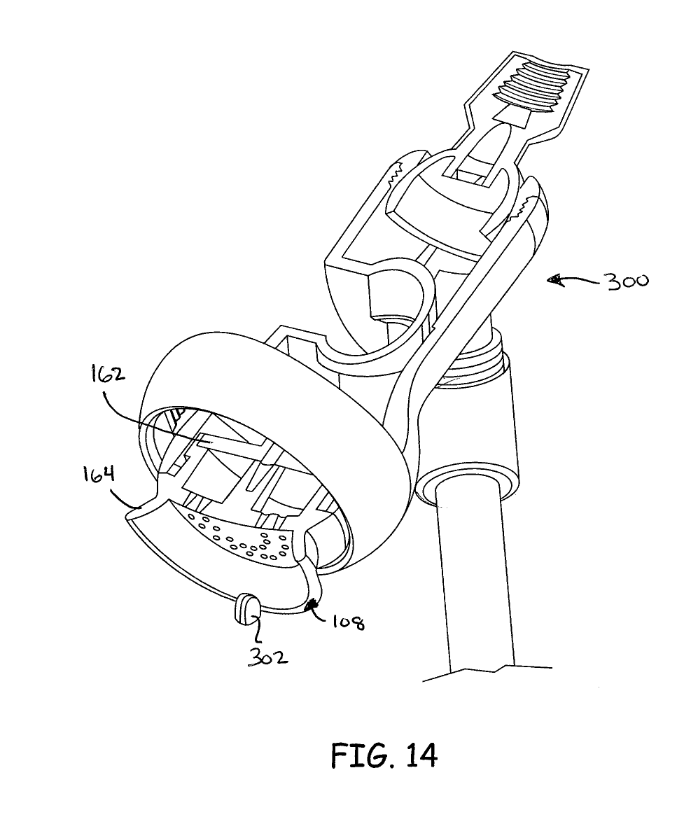

FIGS. 13, 14, and 15 depict a second example of a showerhead assembly 300. Like numbers may be used for components of the second example that are the same or similar to components of the first example. The second example is similar to the first example except for the showerhead 108. Specifically, as shown in FIG. 14, the showerhead 108 does not include a showerhead cover. Instead, the showerhead face member 164 is slightly modified and includes a showerhead tab 302. The showerhead tab 302 helps a user rotate the showerhead face member 164 relative to the showerhead bracket 102 to select a mode of operation for the showerhead 108. The showerhead flow director 162 is also slightly modified to accommodate the modifications to the showerhead face member 164. For example, the showerhead flow director 162 does not have threads since the showerhead face member 164 is joined to the showerhead flow director 162 via a fastener (not shown) extending through centrally located fastener shafts in each member 162, 164. Other than the elimination of the showerhead cover and minor modifications of the showerhead face member 164 and the showerhead flow director 162, the second example of the showerhead assembly 300 is substantially similar to the first example of the showerhead assembly 100 and operates in a manner similar to that described for the first example of the showerhead assembly 100.

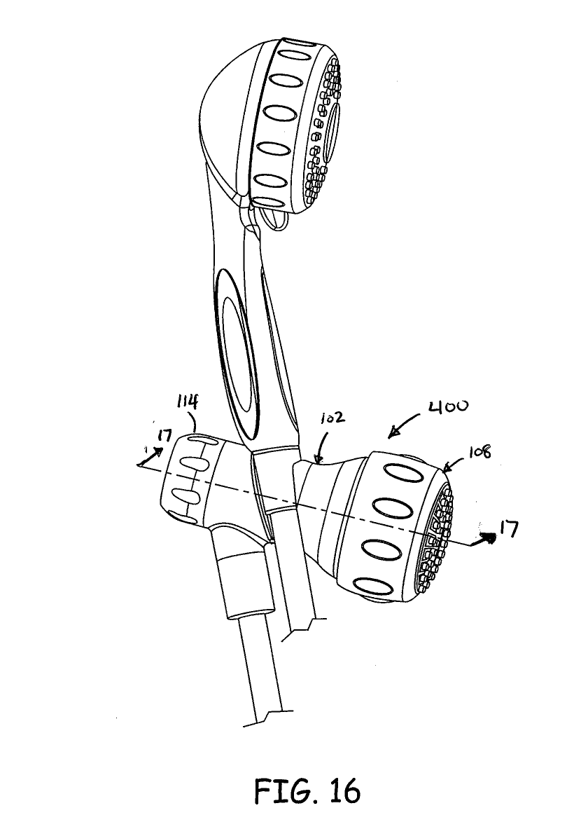

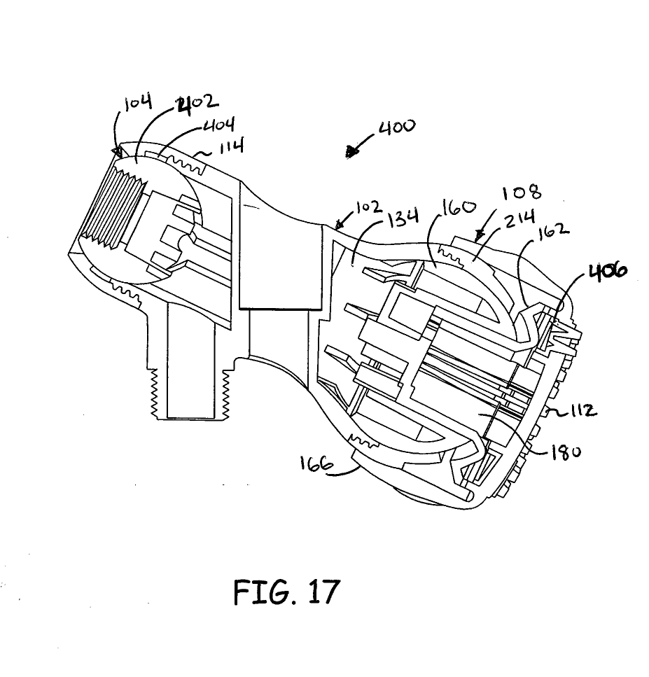

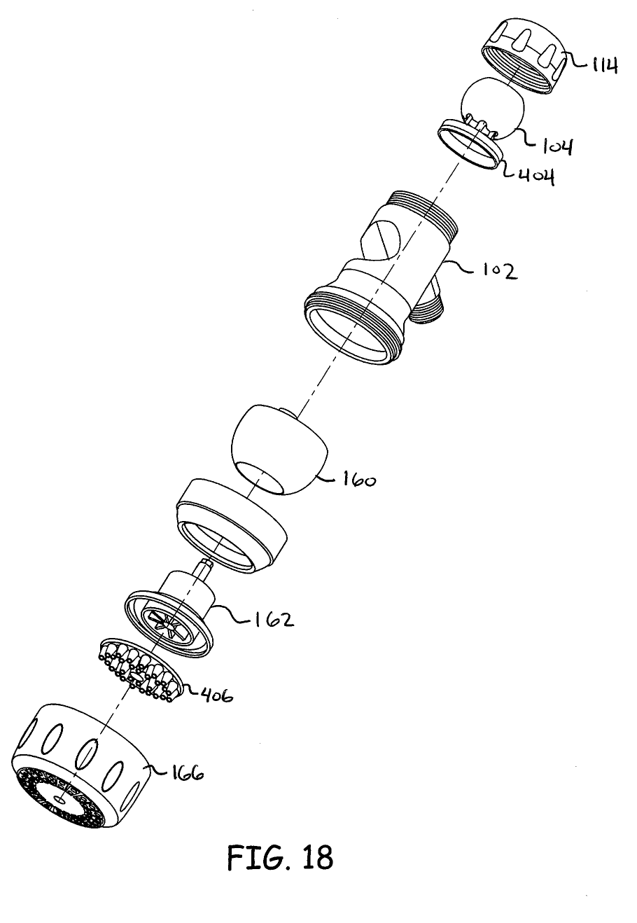

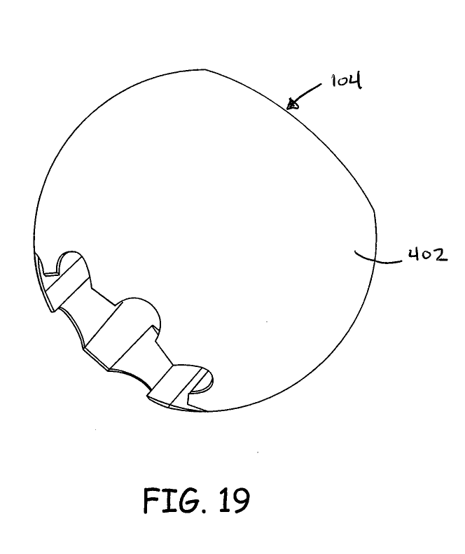

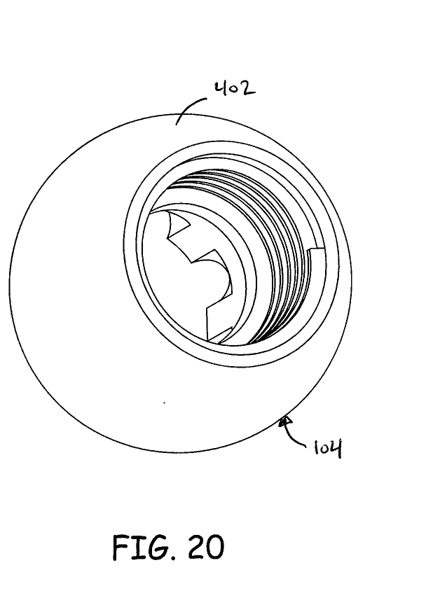

FIGS. 16-18 depict a third example of a showerhead assembly 400. Like numbers may be used for components of the third example that are the same or similar to components of the first and second examples. The third example is similar to the first example except the showerhead assembly 400 includes a different showerhead and a coupling member 104 taking the form of a hidden pivot for connection to the shower pipe. With reference to FIGS. 17-20, the coupling member 104 may include a spherically shaped body 402. An end portion of the coupling member 104 may be threaded for threadedly joining the coupling member 104 to a shower pipe. The coupling member 104 may be joined to the shower pipe using other joining approaches, including, but not limited to press fitting, clamping, and so on. The coupling member 104 may include two or more internal grooves or detents for engagement with a complementary shaped tool to facilitate joining the coupling member 104 to the shower pipe. For example, the tool, such as a screwdriver, may facilitate threading the coupling member 104 onto a shower pipe by providing a hand grip or a mechanical advantage for a user.

A coupling nut 114, may operably join the coupling member 104 to a showerhead bracket 102. The coupling nut 114 may include a curved inner surface complementary to the spherical outer surface of the coupling member 104 to maintain a joined relationship between the coupling member 104 and showerhead bracket 102 while allowing the coupling member 104 to be selectively pivoted and rotated relative to the coupling nut 114 and the showerhead bracket 102. An internal surface of the coupling nut 114 may be internally threaded, as shown in FIG. 17 for example, or externally threaded to mate with threads (shown as external in FIG. 17 but could be internal if desired) on the showerhead bracket 102. Like the coupling nut 114 for the first example of a showerhead assembly 100, the coupling nut 114 for the third example may be joined to the showerhead bracket 102 by other joining methods. Also like the coupling nut 114 for the first example, the coupling nut 114 may include surface features on its exterior surface that facilitate grasping of the coupling nut 114 by a user.

With reference to FIGS. 16 and 17, the coupling nut 114 substantially covers the coupling member 104. Such covering may enhance the aesthetic visual appeal of the showerhead assembly 400, protect the coupling member 104 from damage, and/or increase the ease for cleaning and maintaining the showerhead assembly 400. Further, using the coupling nut 114 to join the coupling member 104 to the showerhead bracket 102 may enhance the safety to a shower user or minimize damage to the shower by maintaining the connection between the shower pipe and the showerhead bracket 102 even if the coupling member 104 should crack or otherwise fail.

Turning to FIG. 17, a generally partially spherical seal member 404 may be positioned between the coupling nut 114 and the coupling member 104. The seal member 404 may form a substantially water tight seal between the coupling nut 114 and the coupling member 104 to prevent water or other fluid from passing between these two elements. Similar to the first example, in lieu of or in combination with a sealing member 404, one or more abutting surfaces of the coupling nut 114 and the coupling member 104 may be made of, or coated with, a resilient matter (e.g., rubber or other suitable material) to prevent fluid from leaking through the respective joints formed between them.

With continued reference to FIG. 17, the showerhead 108 for the third showerhead assembly 400 example may include a showerhead barrel 160, a flow director 162, a showerhead nozzle member 406, and a showerhead cover 166. In a manner similar to the first showerhead assembly 100 example, the flow director member 162 may be selectively rotated relative to the showerhead barrel 160 using the showerhead cover 166, and the assembled showerhead components may be selectively pivoted relative to the showerhead bracket 102 to change the coverage area of water or other fluid that exits the showerhead 108.

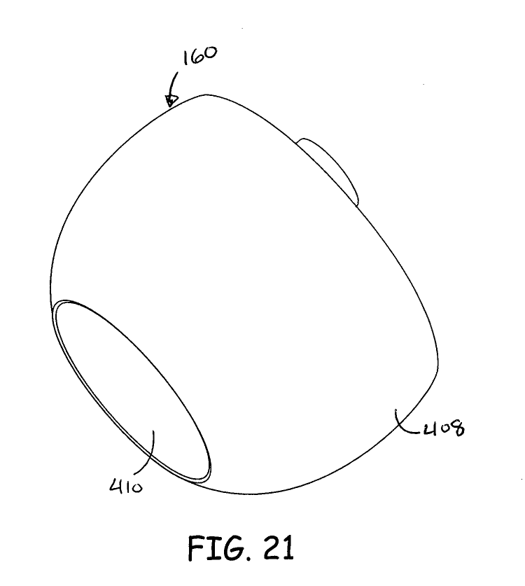

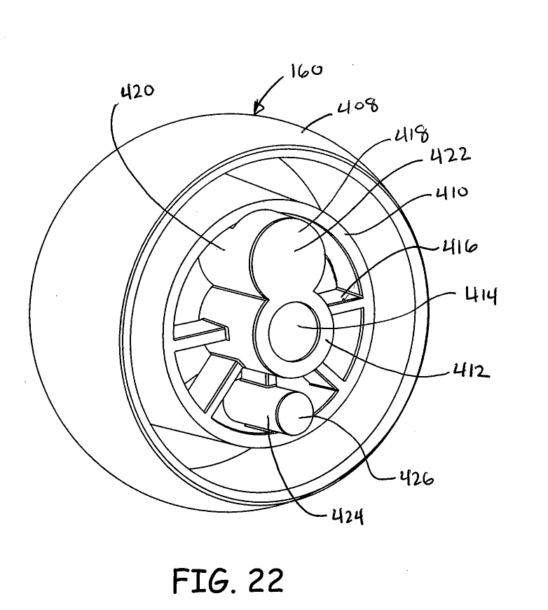

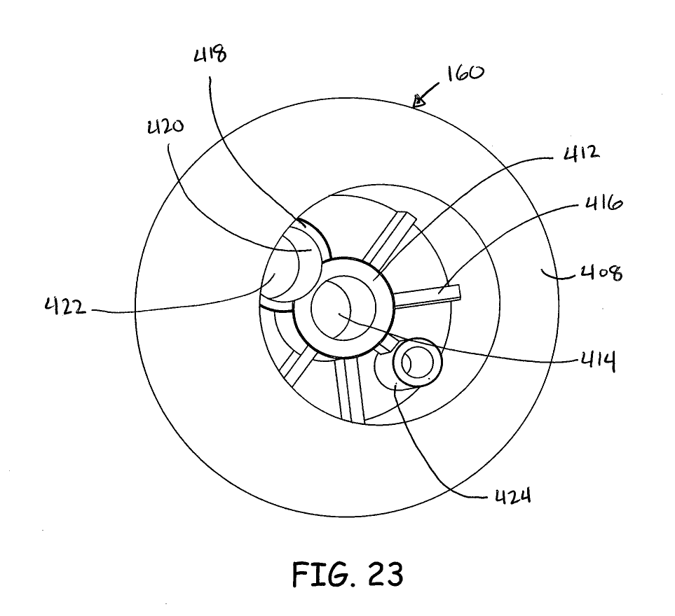

With reference to FIGS. 17 and 21-23, the showerhead barrel 160 may include outer and inner showerhead barrel walls 408, 410. The outer showerhead barrel wall 408 may be partially spherical shaped with an end portion joined to an end portion of the inner showerhead barrel wall 410. Like the first example, the curved partial spherical shaped outer showerhead barrel wall 408 may complement an inner curved surface of the showerhead bracket 102 to permit selectively pivoting of the showerhead barrel 160 relative to the showerhead bracket 102. The inner showerhead barrel wall 410 may be generally cylindrical and may define a showerhead barrel opening within the showerhead barrel 160.

Within the showerhead barrel opening, the showerhead barrel 160 may include a showerhead barrel fastener wall 412. The showerhead barrel fastener wall 412 may be cylindrical or any other desired shape and may define a fastener opening 414 for receiving a fastener to join the showerhead barrel 160 to the flow director 162. Showerhead barrel arms 416 extending radially inward from the inner showerhead barrel wall 410 may join the showerhead barrel fastener wall 412 to the inner showerhead barrel wall 410. The combination of the showerhead barrel arms 416 and the showerhead barrel fastener wall 412 may resemble a hub with radial extending spokes.

Proximate the showerhead barrel fastener wall 412, a cup-like showerhead barrel fluid closure 418 may be defined by a showerhead barrel fluid closure wall 420 and base 422. The showerhead barrel fluid closure wall 420 may be joined to the inner showerhead barrel wall 410 and the showerhead barrel fastener wall 412 by integrally forming it with these elements or by any other suitable connection method. The showerhead barrel fluid closure 418 may be selectively aligned with a fluid opening 224 in the flow director 162 to prevent fluid communication between the fluid chamber 134 in the showerhead bracket 102 and a showerhead fluid chamber 180 defined by the flow director 162 and the showerhead cover 166. When the showerhead barrel fluid closure 418 is not aligned with the flow director fluid opening 224, there may be fluid communication between the showerhead bracket fluid chamber 134 and the showerhead fluid chamber 180. For example, an open space defined by the showerhead barrel arms 416 may align with the flow director fluid opening 224 to allow fluid flow between the showerhead bracket fluid chamber 134 and the showerhead fluid chamber 180. The showerhead barrel fluid closure 418 may be selectively aligned and not aligned with the flow director fluid opening 224 by rotating the flow director 162 relative to the showerhead barrel 160.

Like the first example, a mode indicator, such as a mode indicator plunger and spring (not shown), may provide an indication to a user when a showerhead mode is successfully selected by the user. Like the first example, the mode indicator components may be received within a generally annular or cylindrical mode indicator wall 424 closed at one end by a mode indicator base 426 and joined to the inner showerhead barrel wall 410. Like the first example, the mode indicator wall 424 may receive the mode indicator spring and the mode indicator plunger and may function in a manner similar to the mode indicator in the first example.

With reference to FIG. 17, a showerhead nut 214 joined to the showerhead bracket 102 may maintain the connection between the showerhead barrel 160 and the showerhead bracket 102 in a manner similar to the one described above for the first example. Similar to the first example, an O-ring or other suitable sealing member may be placed within an annular cavity defined by the showerhead bracket 102, the showerhead nut 214, and the showerhead barrel 160 to prevent fluid leakage from the showerhead bracket fluid chamber 134 through the joints formed by these members. Also like the first example, one or more abutting surfaces of the showerhead barrel 160, the showerhead bracket 102 and the showerhead nut 214 may be made of, or coated with, a resilient material in lieu of or in combination with a sealing member.

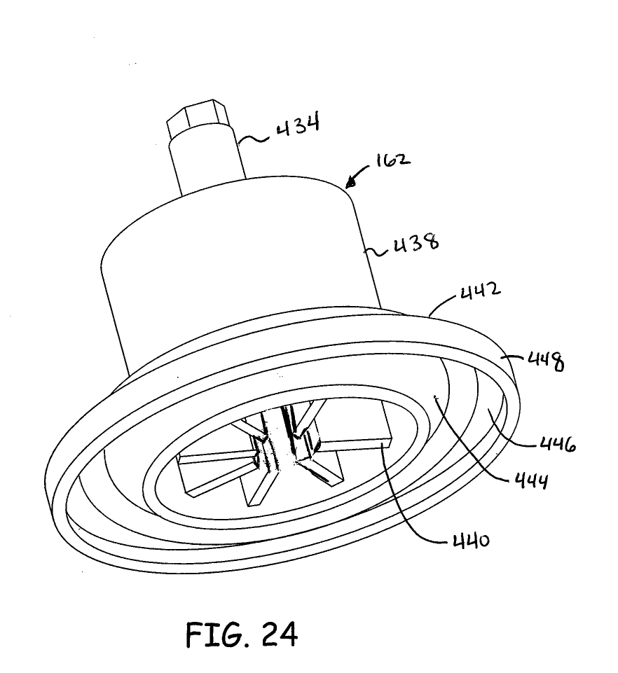

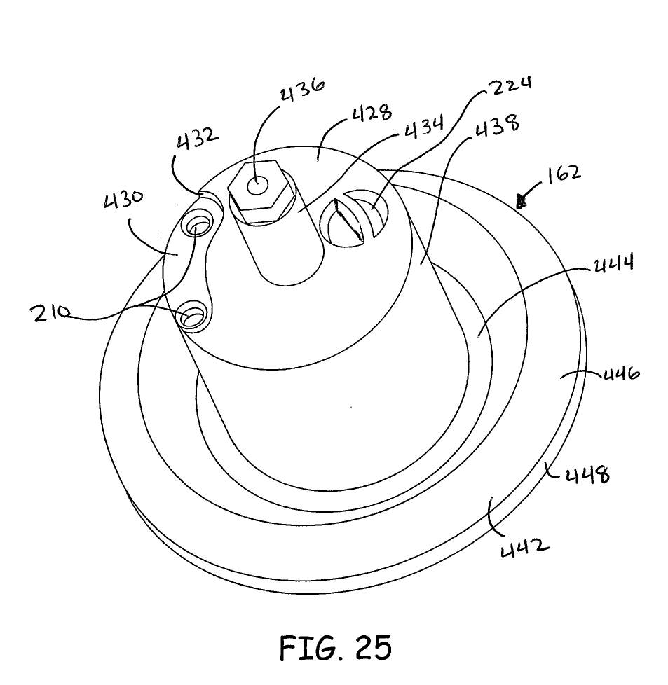

With reference to FIGS. 17, 24 and 25, the flow director 162 may include a flow director base 428 defining the flow director fluid opening 224. As discussed above, the flow director fluid opening 224 may be selectively placed in and removed from fluid communication with the showerhead bracket fluid chamber 134. When not in fluid communication with the showerhead bracket fluid chamber 134, water will not flow to the showerhead fluid chamber 180 and thus water will not flow from the showerhead 108 (i.e., the showerhead 108 will be in an off mode). A pair of mode indicator holes 210, recesses or detents may be defined in the flow director base 428. In a manner similar to the first example, the mode indicator holes 210 may be arranged to indicate in conjunction with the mode indicator plunger whether the flow director fluid opening 224 is aligned with the showerhead barrel fluid closure 418 or an opening in the showerhead barrel 160. The mode indicator holes 210 may be defined within a recessed area 430 of the flow director base 428, which may be at least partially encompassed by a mode indicator stop wall 432. In a manner similar to the mode indicator stops 232 of the first example, the mode indicator stop wall 432 may limit the range of rotation of the flow director 162 relative to the showerhead barrel 160.

A flow director fastener shaft 434 may extend from the flow director base 428. The flow director shaft 434 may be generally cylindrical and may define a flow director fastener opening 436 for receiving a fastener to rotatably join the flow director 162 to the showerhead barrel 160. The flow director fastener shaft 434 may be received through the showerhead barrel fastener opening 414. The cylindrical shape of the flow director fastener shaft 434 may complement the cylindrical shape of the showerhead barrel fastener wall 412 to allow rotation of the flow director 162 relative to the showerhead barrel 160.

A flow director wall 438 may extend from a perimeter or edge of the flow director base 428 in a direction approximately opposite the direction the flow director fastener shaft 434 extends from the flow director base 428. The flow director wall 438 may be generally cylindrical and sized for receipt within a space defined by the inner showerhead barrel wall 410. The cylindrical shape of the flow director wall 438 may allow rotation of the flow director 162 relative to the showerhead barrel 160 when the flow director wall 438 and the inner showerhead barrel wall 410 abut as shown, for example, in FIG. 17. If desired, the flow director wall 438 may be sized not to abut the inner showerhead barrel wall 410. When so sized, the flow director wall 438 may be configured to form any desired shape. Flow director arms 440 or spokes may extend radially inward from the inner surface of the flow director wall 438. The flow director arms 440 or spokes may stiffen the flow director wall 438 and/or may be included for visual appeal.

A flow director flange 442 may extend radially outward from an end portion of the flow director wall 438. The flow director flange 442 may include an inner portion 444 having curved, convex shaped lower surface, a middle portion 446 extending in a downward slope from an outer perimeter of the inner portion 444, and an outer portion 448 extending vertically downward from an outer perimeter of the middle portion 446. The flow director flange 442 and the nozzle member 406 may define a fluid receiving area in fluid communication with the showerhead fluid chamber 180. Although shown as divided into three portions with differing shapes, the flow director flange 442 may be any desired shape to form an area for receiving fluid from the showerhead fluid chamber 180.

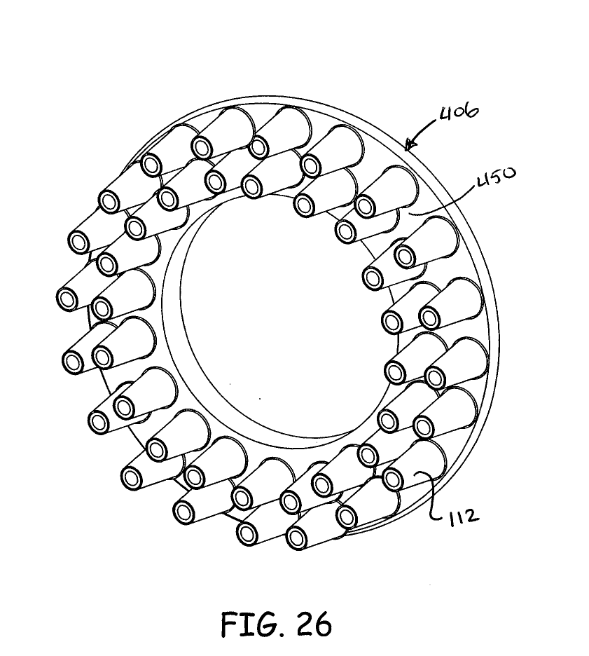

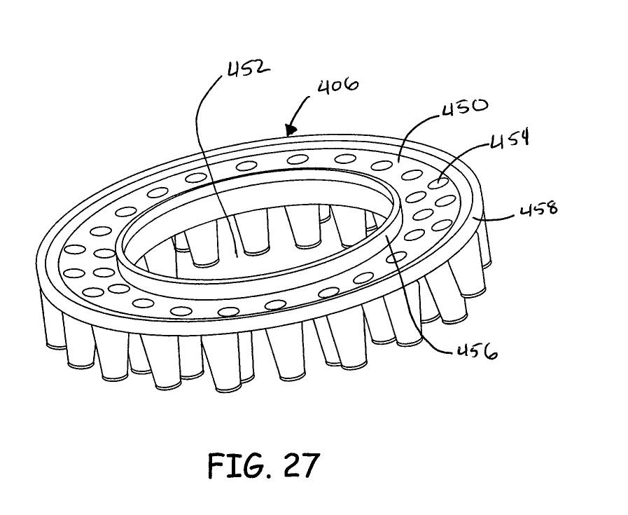

Turning to FIGS. 17, 26 and 27, the nozzle member 406 may include a nozzle member base 450. The nozzle member base 450 may be generally annular and may define a nozzle member cover opening 452 for receipt of a portion of the showerhead cover 166. Nozzles 112 may extend from the nozzle member base 450. Each nozzle 112 may define a fluid passage aligned with a fluid opening 454 defined in the nozzle member base 450. Inner and outer nozzle member walls 456, 458 may extend from the nozzle member base 450 in a direction generally opposite the nozzles 112. Together, the inner and outer nozzle member walls 456, 458 and the nozzle member base 450 may define a channel. With reference to FIG. 17, the nozzle member channel and the flow director flange 442 may define the space for receiving fluid from the showerhead fluid chamber 180. Fluid received within this space may flow out of the showerhead 108 through the nozzles 112, which are fluidly connected to this space.

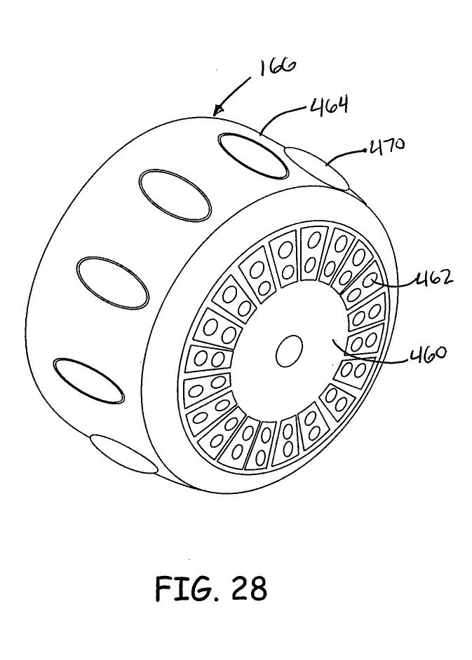

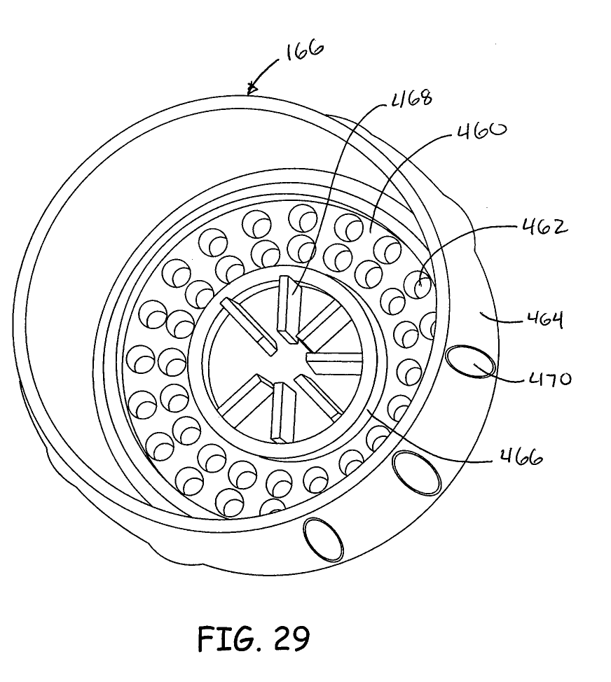

With reference to FIGS. 17, 28 and 29, the showerhead cover 166 may include a showerhead cover base 460 containing showerhead cover holes 462 for receiving the nozzles 112 of the nozzle member 406. An outer showerhead cover wall 464 may extend from the showerhead cover base 460. The outer showerhead cover wall 464 may be generally cylindrical with a slight outward convex curve. A portion of the outer showerhead cover wall 464 may cover a portion of the showerhead nut 214. The showerhead cover 166 may include an inner showerhead cover wall 466 spaced apart from the outer showerhead cover wall 464 and extending from the showerhead cover base 460 in generally the same direction as the outer showerhead cover wall 464. The nozzle member base 450 may be received between the inner and outer showerhead cover walls 464, 466. Showerhead cover arms 468 may extend radially inward from the inner showerhead cover wall 466 in a spoke pattern. The showerhead cover arms 468 may align with and abut the flow director arms 440.

Like the showerhead cover 166 in the first example of a showerhead assembly 100, the showerhead cover 166 may be suitably joined to the showerhead nozzle member 406 and/or the flow director 162 to transmit any rotating or pivoting of the showerhead cover 166 relative to the showerhead bracket 102 to these other components of the showerhead 108. Further, selective rotation of the showerhead cover 166 relative to the showerhead bracket 102 may rotate the flow director 162 relative to the showerhead barrel 160 to change the operation mode of the showerhead 108. The showerhead cover 166 may include one or more projections 470 as shown in FIGS. 17, 28 and 29, or indentations, to facilitate grasping of the showerhead cover 166 by the user to rotate or pivot the showerhead cover 166 relative to the showerhead bracket 102.

Although various elements of the examples of the showerhead assembly, including, but not limited to, the showerhead bracket, the showerhead and the coupling member, have been described with certain specificity, the various showerhead assembly elements may take other shapes and forms or may consist of more or less components. Further, different showerheads than those depicted and described herein may used with the showerhead bracket, including, without limitation, showerheads that do not pivot and/or rotate relative to the showerhead bracket, showerheads that have operating modes other than those described and depicted, showerheads that have more or less operating modes, showerheads that contain turbines to generate pulsating sprays, and so on. As an example, Table 1 provides examples of some possible modes for a showerhead.

TABLE 1
Examples of Two Mode Showerheads

| Showerhead | First Mode of | Spray Mode(s) |
|---|---|---|
| Example # | Operation | of Operation |
| 1 | Off | Body Spray |
| 2 | Off | Mist Spray |
| 3 | Off | Single Speed Pulse |
| 4 | Off | Variable Speed Pulse |
| 5 | Off | Two-Speed Pulse |
| 6 | Off | Low Speed Power Pulse |
| 7 | Off | Three Dimensional Spray |
| 8 | Off | Fan Spray |
| 9 | Off | Fluidic Pulse |
| 10 | Off | Dynamic Spray |
| 11 | Off | Multiple Spray Modes Via 360° Rotation |
| | | of Showerhead Face |

As another example, the showerhead may be configured to have an off mode and to operate in at least two different spray modes for a total of at least three modes of operation. Table 1 and the examples set forth herein are merely illustrative of potential modes of operation for a showerhead and are not intended to be limiting.

The coupling member, the showerhead bracket, and other elements of the various examples of the showerhead assembly may be integrally formed or may be made of two or more separate components that are joined together by mechanical fasteners, sonic or heat welds, adhesives, chemical bonds, any other suitable method, or any combination thereof. All directional references (e.g., upper, lower, upward, downward, left, right, leftward, rightward, top, bottom, above, below, vertical, horizontal, clockwise, and counterclockwise) are only used for identification purposes to aid the reader's understanding of the examples of the invention, and do not create limitations, particularly as to the position, orientation, or use of the invention unless specifically set forth in the claims. Joinder references (e.g., attached, coupled, connected, joined and the like) are to be construed broadly and may include intermediate members between the connection of elements and relative movement between elements. As such, joinder references do not necessarily infer that two elements are directly connected and in fixed relation to each other.

In some instances, components are described by reference to “ends” having a particular characteristic and/or being connected with another part. However, those skilled in the art will recognize that the present invention is not limited to components which terminate immediately beyond their point of connection with other parts. Thus the term “end” should be broadly interpreted, in a manner that includes areas adjacent rearward, forward of or otherwise near the terminus of a particular element, link, component, part, member or the like. In methodologies directly or indirectly set forth herein, various steps and operations are described in one possible order of operation but those skilled in the art will recognize the steps and operation may be rearranged, replaced or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

What I claim is:

1. A showerhead assembly comprising:
a showerhead bracket comprising a fluid chamber and a slot configured to securely and releasably receive a handheld showerhead; and
a showerhead operatively associated with the showerhead bracket and in fluid communication with the fluid chamber, wherein at least a portion of the showerhead is received within the fluid chamber and the showerhead is selectively movable relative to the showerhead bracket.

2. The showerhead assembly of claim 1, wherein:
the showerhead bracket further comprises a fluid inlet in fluid communication with the fluid chamber and upstream of the showerhead; and
the slot is located between the fluid inlet and the showerhead.

3. The showerhead assembly of claim 2, wherein the slot is aligned along a longitudinal axis of the showerhead bracket.

4. The showerhead assembly of claim 2, wherein:
the showerhead bracket further comprises a fluid outlet in fluid communication with the fluid chamber;
and the showerhead is located downstream of the fluid outlet.

5. The showerhead assembly of claim 4, further comprising a diverter valve located between the fluid inlet and the fluid outlet.

6. The showerhead assembly of claim 5, wherein the diverter valve may be selectively moved to control fluid flow between the fluid inlet, the fluid outlet and the showerhead.

7. The showerhead assembly of claim 2, further comprising a coupling member operatively associated with the showerhead bracket and in fluid communication with the fluid inlet.

8. The showerhead assembly of claim 7, wherein the coupling member is selectively movable relative to the showerhead bracket.

9. The showerhead assembly of claim 8, wherein the coupling member is selectively rotatable and pivotable relative to the showerhead bracket.

10. The showerhead assembly of claim 1, wherein the showerhead is configured to operate in at least one mode.

11. The showerhead assembly of claim 10, wherein each mode is selectable by rotating the showerhead relative to the showerhead bracket.

12. The showerhead assembly of claim 1, wherein a fluid flow through the showerhead is selectively controlled by rotating the showerhead relative to the showerhead bracket.

13. The showerhead assembly of claim 10, wherein one mode of the at least one mode is off.

14. The showerhead assembly of claim 1, wherein the showerhead is selectively rotatable and pivotable relative to the showerhead bracket.

15. The showerhead assembly of claim 4, wherein the fluid outlet is in fluid communication with the handheld showerhead.

16. The showerhead assembly of claim 4, wherein the showerhead bracket further comprises at least one additional fluid outlet in fluid communication with the fluid inlet and with at least one additional handheld showerhead.

17. A showerhead assembly comprising:
a showerhead bracket comprising a slot aligned along an longitudinal axis of the showerhead bracket and configured to securely and releasably receive a handheld showerhead, a fluid chamber, a fluid inlet in fluid communication with the fluid chamber, and a fluid outlet in fluid communication with the fluid inlet; and
a showerhead operatively associated with the showerhead bracket and in fluid communication with the fluid chamber, wherein at least a portion of the showerhead is received within the fluid chamber.

18. A method of providing a fluid spray from a shower pipe comprising:
obtaining a showerhead assembly comprising a showerhead bracket including a slot configured to securely and releasably receive a handheld showerhead, a fluid chamber, a fluid inlet in fluid communication with the fluid chamber, a fluid outlet in fluid communication with the fluid inlet, a showerhead in fluid communication with the fluid chamber, the showerhead operatively associated with the showerhead bracket and selectively movable relative to the showerhead bracket, and at least a portion of the showerhead is received within the fluid chamber; and
fluidly connecting the fluid inlet of the showerhead bracket with a fluid outlet of the showerhead pipe.
